(19) United States
(12) Patent Application Publication
(10) Pub. No.: US 2026/0289721 A1
(43) Pub. Date: Sep. 24, 2026

(54) RENDER TARGET LOCALIZATION IN A MULTI-CHIP GPU

(71) Applicant: NVIDIA Corporation, Santa Clara, CA (US)

(72) Inventors: Ziyad HAKURA, Santa Clara, CA (US); Yan ZHANG, Santa Clara, CA (US); Eric LUM, Santa Clara, CA (US); Andrei KHODAKOVSKY, Santa Clara, CA (US); Eric WERNESS, Santa Clara, CA (US); Emmett KILGARIFF, Santa Clara, CA (US); Wishwesh Gandhi, Santa Clara, CA (US); Michael Fetterman, Santa, CA (US)

(21) Appl. No.: 19/087,064

(22) Filed: Mar. 21, 2025

(51) Int. Cl. G06T 1/60; G06T 1/20

(52) U.S. Cl. CPC G06T 1/60; G06T 1/20

(57) ABSTRACT

Methods and systems are described for localizing render targets in a multi-chip graphics processing unit (GPU) thereby reducing the inter-chip traffic and improving the latency of certain rendering. The localization techniques provide for storing surfaces of different bit densities on the same locally connected memory, and enabling access to the different surfaces in a similar manner. The described localizing may be implemented over an interleaving of the virtual memory on the locally connected memories of each die in the multi-chip GPU.

### CROSS-REFERENCE TO RELATED APPLICATIONS

None.

### FIELD

The technology herein relates to graphics processing units (GPUs) and to reducing congestion of chip-to-chip communication connections in multi-chip GPUs. More particularly, the technology herein relates to distributing data and/or work to memory devices connected to respective chips in the multi-chip GPU so that use of bandwidth on the chip-to-chip communication connection is reduced.

### BACKGROUND & SUMMARY

Modern high performance computing systems provide high degrees of parallel execution in both a multi-core central processing unit (CPU) and in one or more graphics processing units (GPUs) the CPU supervises and controls.

GPU hardware subsets—which are sometimes called “Graphics Processing Clusters” or GPCs—comprise the dominant high-level hardware block of many GPUs. In some designs, each GPC includes dedicated pipelined graphics rendering hardware, plus a number of “streaming multiprocessors” (“SMs”) or other software-programmable processing cores capable of executing shader software. The graphics pipelined rendering hardware of each GPC may comprise one or more Primitive Engines and one or more Raster Engines. Each Primitive Engine is responsible for handling Vertex Fetch, Tessellation, Viewport Transform, Attribute Setup, and Stream Output, and supports out of order execution to provide parallelism and hide memory system latency. Each Raster Engine does edge/triangle setup, rasterization, and z-culling in a pipelined manner and provides plural raster operation partitions (“ROPs”) (each partition containing a number of ROP units). Primitive Engine(s) and Raster Engine(s) collectively accelerate operation-intensive rendering processes such as polygon shading, level of detail control, texture mapping, hidden surface removal/alpha transparency processing, rasterization, tessellation, etc. under control of one or more programmable software shaders executing on the SMs. Each SM in turn may contain many processing cores, some number of Tensor Cores, a Register File, some number of Texture Units, and L1/Shared Memory which can be configured as differently sized sub-partitions depending on the needs of the compute or graphics workloads. Each GPC also needs to be able to access memory so it can store and retrieve data needed for its tasks. Such GPCs are the basic functional building blocks of the GPU.

More and more GPCs can be packed into the same GPU to increase parallelism—but providing each GPC with high speed memory access can become increasingly challenging. As graphics processing units (GPUs) scale, a fully connected “crossbar” (xbar) between each GPC and the memory subsystem would be too costly to build. Some GPU designs instead structured some GPUs so that multiple GPCs form a “micro GPU” (uGPU). Each uGPU comprises GPCs and on-chip “L2” (level 2) cache memory connected together using a fully connected crossbar. These internally fully connected uGPU clusters are then connected together using L2 network-on-chip (“NOC”) or chip-to-chip (“C2C”) connections to form a big GPU that is referred to in this disclosure as a “multi-chip GPU” or a “multi-die GPU”. See FIGS. 1 & 1A and e.g., U.S. Pat. No. 10,915,445.

FIG. 2 shows a number of frame buffer partitions connected across different GPCs. The screen is subdivided across GPCs based on a screen mapping. Each GPC operates on their own assigned portions of the framebuffer. In this example, no GPCs have to render the entire frame buffer; instead, they work together in a coordinated fashion to “divide and conquer”. Specifically, the frame buffer is cut up checkerboard-like style into a number of different areas called “tiles” (e.g. raster tiles referred to later in this disclosure), and each GPC's raster engine is assigned a different set of one or more tiles for rendering into. For each render target configuration, graphics objects are first processed in a world space pipeline. The world space pipeline creates graphics primitives associated with the graphics objects. The world space pipeline provides the graphics primitives to all raster engines responsible for rendering into their respective tiles. For each primitive coming into a GPC, the GPC stores the primitive into some number of per-tile bins (e.g., buffers), corresponding to the tiles that the primitive intersects with, and where a tile represents a distinct portion of the screen surface designated to that GPC only. After the primitives are sorted into bins, for each tile, all the graphics primitives for a tile are then processed by the GPC's screen space pipeline that is temporarily configured to render only the pixels of that particular screen tile before moving on. An example graphics pipeline with its constituent world space pipeline and screen space pipeline is shown in FIG. 3. See also e.g., U.S. Pat. No. 8,704,826, the entire disclosure of which is herein incorporated by reference. In the manner described, each GPC hardware unit is able to render into its own subset of tiles of the frame buffer-much like a number of quilters can fashion different quilt squares independently and then all their squares are stitched together into a single large quilt.

The GPCs rendering different tiles are able to communicate via the system's unified memory architecture. In the FIG. 2 example, each uGPU comprises a number (e.g., four) GPCs connected by a memory management unit (MMU) to a “crossbar”. The GPCs use the crossbar to access stacks of high bandwidth memory (“HBM”) or GDDR memory comprising dynamic random access memory (DRAM) chips forming the GPU's memory subsystem backed by an on-chip cache (e.g., L2). See e.g., U.S. Pat. No. 11,663,036. The crossbars also provide a high speed communications interface that permits the uGPUs to communicate with one another. The crossbars provide a communications path between each uGPU and an “NVLINK” NOC communications interface that enables the GPU to communicate with other GPUs that in turn are composed of uGPUs comprising GPCs. Such crossbars are for example able to communicate information produced by the world space pipelines of each uGPU to the screen space pipelines of any uGPU. Thus, each uGPU is able to communicate with any other uGPU in the system and each GPC is able to access the memory of any other GPC-offering tremendous flexibility in terms of parallelism, processing coordination and data sharing. Such flexibility is consistent with the unified virtual addressing shown in FIG. 3A. See e.g., CUDA Programming Guide v12.1 Section 19 (“Unified Memory Programming”).

While the above arrangement has worked well for a number of years, there is now a need to increase the complexity of a single GPU beyond what can fit on a single reticle used to manufacture the semiconductor dies that make up integrated circuit chips. This means that the single GPU can now span across multiple semiconductor dies, with coordination and communications between the dies to allow the multiple dies to operate as a unified multi-chip GPU. See, e.g., U.S. application Ser. No. 18/606,924 filed on Mar. 15, 2024.

For purposes of description below, and without limitation, an example multi-chip GPU with two dies each with one uGPU fabricated on it is used. The bandwidth of the chip-to-chip (C2C) connection between the two dies is a resource that is important for performance of the multi-chip GPU. Therefore, methods and systems for reducing the bandwidth usage of the C2C connection in a multi-chip GPU are desired.

### BRIEF DESCRIPTION OF THE DRAWINGS

FIGS. 1 & 1A are block diagrams of a prior art GPU architecture providing inter-GPU communications.

FIG. 2 is a block diagram of a prior art GPU architecture.

FIG. 3 is a block diagram showing a prior art graphics processing pipeline.

FIG. 3A is a block diagram showing prior art unified virtual addressing within a processing system including multiple GPUs.

FIG. 4 is a block diagram of an example multi-chip GPU architecture according to some embodiments.

FIG. 5 illustrates a scenario where render targets are split between the framebuffers attached to the two dies in a two-chip GPU with localization of render targets, according to some embodiments.

FIG. 6A illustrates a definition of group of blocks (GOB) as a function of bits per pixel (BPP) of a surface, a raster tile, and a newly defined uGPU tile, according to some embodiments.

FIG. 6B illustrates example anti-aliasing (AA) modes and corresponding uGPU tile sizes, according to some embodiments.

FIGS. 7A-7C show virtual address swizzles for 8 BPP, according to some embodiments.

FIGS. 7D-7F show virtual address swizzles for 16 BPP, according to some embodiments.

FIGS. 7G-7H show virtual address swizzles for 32 BPP, according to some embodiments.

FIG. 7I shows a virtual address swizzle for 64 BPP, according to some embodiments.

FIG. 7J shows a virtual address swizzle for 128 BPP, according to some embodiments.

FIG. 8 illustrates a block diagram of circuitry to perform a blocklinear (BL) to virtual address (VA) swizzle for accessing localized blocklinear surfaces, according to some embodiments.

FIG. 9A shows an example mapping to uGPU from (x,y) screen coordinates in a two-chip GPU, according to some embodiments.

FIG. 9B shows an example mapping from screen (x,y) coordinates to uGPU in a system with unequal number of data processing clusters (DPCs) in each uGPU in 1×AA mode, according to some embodiments.

FIG. 9C shows an example GPC mapping table, according to some embodiments.

FIG. 9D shows an example of raster tile allocations to GPCs within each uGPU tile, according to some embodiments.

FIG. 10 is a flowchart of a method for render target localization according to some embodiments.

FIG. 11 is a flowchart of a method for storing data of pixels in a first surface of a render target in the locally connected memory of one of the first die or the second die, in accordance with some embodiments of the present disclosure.

FIG. 12 is a flowchart of a method for determining the virtual address in the process of FIG. 11, according to some embodiments

FIG. 13 illustrates an example parallel processing unit of a GPU, according to some embodiments.

FIG. 14A illustrates an example general processing cluster (GPC) within the parallel processing unit of FIG. 4, according to some embodiments.

FIG. 14B illustrates an example memory partition unit of the parallel processing unit of FIG. 13.

FIG. 15A illustrates an example streaming multiprocessor (SM) of FIG. 14A, according to some embodiments.

FIG. 15B conceptually illustrates four subpartitions implemented in an SM such as the SM shown in FIG. 15A, according to some embodiments.

FIG. 16A is an example conceptual diagram of a processing system implemented using the parallel processing unit (PPU) of FIG. 13.

FIG. 16B is a block diagram of an exemplary system in which the various architecture and/or functionality of the various previous embodiments may be implemented.

### DETAILED DESCRIPTION OF NON-LIMITING EMBODIMENTS

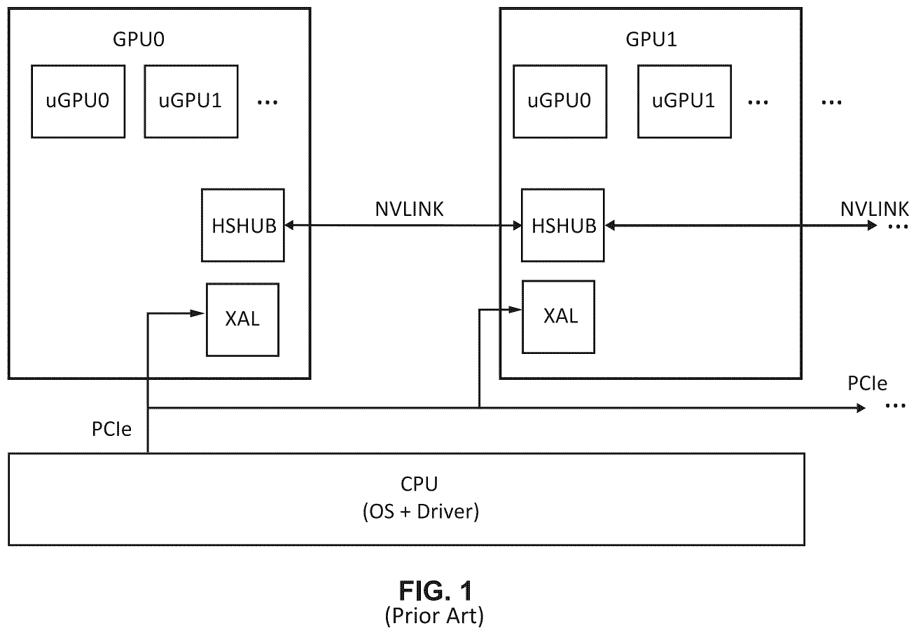

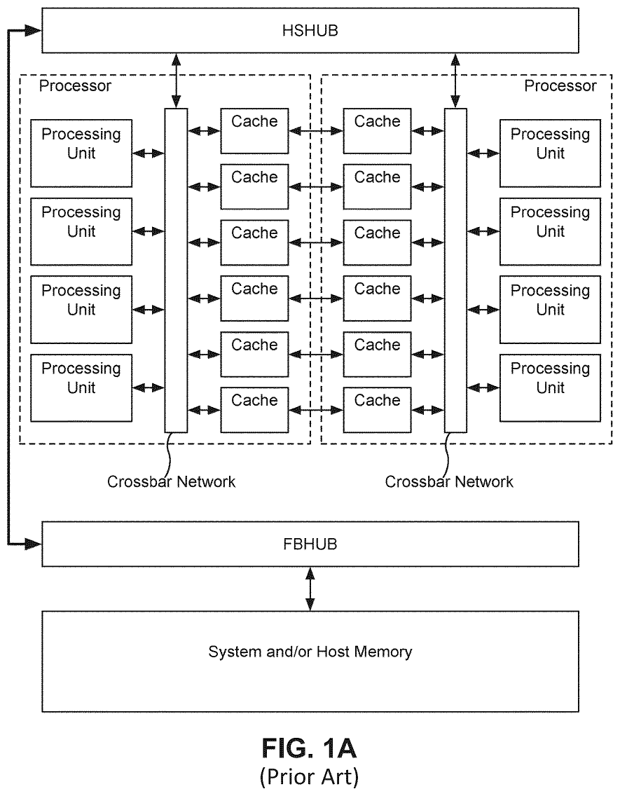

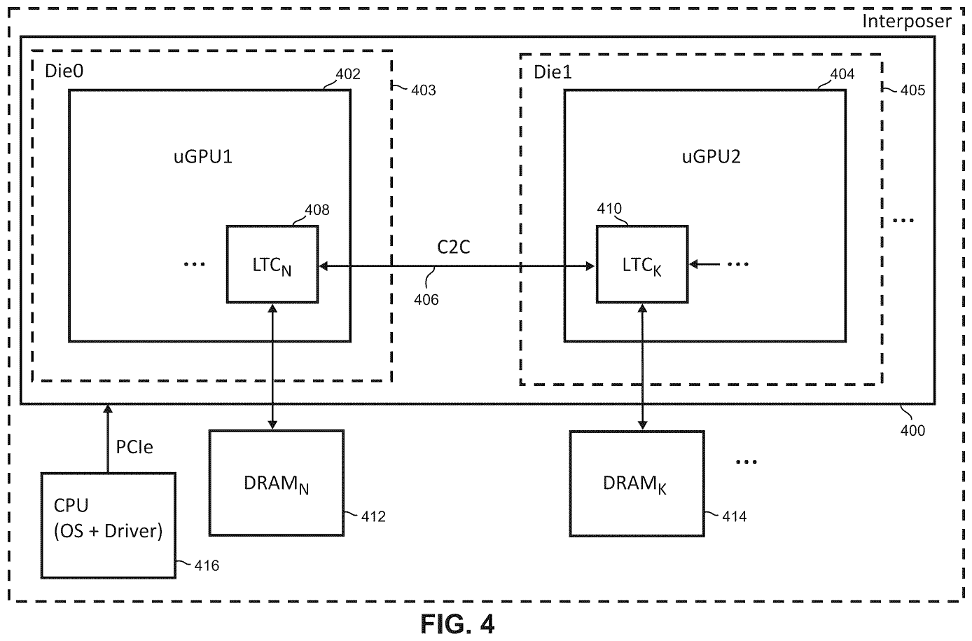

The term “multi-chip GPU,” as used in this disclosure, may refer to a single GPU that has two or more uGPUs each on a separate die, as, for example, shown in FIG. 4, or a system that has two or more GPUs each of which may or may not have one or more uGPUs. FIG. 1 illustrates an example system with two GPUs (GPU0 and GPU1) each of which has a plurality of uGPUs (uGPU0, uGPU1, . . . ). However, as noted above and without limitation, an example two-chip GPU with one uGPU disposed on each die is used for purposes of the description below. The terms “die” and “chip” are used interchangeably in this disclosure.

When a GPU's graphics rendering hardware is distributed across multiple dies as in a multi-chip GPU, the rendering hardware on each die can be used to generate a part of the framebuffer for the display image. However, collaboration between the rendering hardware on separate dies in the multi-chip GPU can result in heavy use of the inter-chip bandwidth, such as, for example, the bandwidth of the chip-to-chip (C2C) interface shown in FIG. 4. The C2C interface bandwidth is a resource of which the use should be optimized in a multi-chip GPU.

In a multi-chip GPU that has a common unified memory, the same virtual address space is accessible to all uGPUs and is distributed over the locally connected memories (e.g., physical memory, DRAM) of each of the uGPUs. Each uGPU writes to the virtual address space, and, in accordance with the common unified memory, the written data may be stored in the locally connected physical memory of another uGPU. Thus, controlling the use of C2C bandwidth can become more of an issue in a multi-chip GPU that has a common unified memory. The technology disclosed in this disclosure solves problems relating to the use of C2C interface bandwidth that cause one uGPU to access the locally connected memory of another uGPU. Example solutions provide new functionality in both hardware and software.

Example embodiments schedule the work and arrange memory in a multi-chip GPU in such a way that most accesses to the render targets are performed locally to each die in the multi-chip GPU. Performed locally, in the context of a pixel shader, means that the pixel shader for a particular fragment running on a particular die accesses the locally connected memory of that die (i.e. DRAM that is directly attached to that particular die) in order to read or write the render target surfaces that correspond to that fragment. Thus, render targets generated in the graphics pipelines are localized to the locally connected memory of each die in accordance with the screen positions of corresponding pixels. For example, the render targets for pixels in a particular rectangular tile area, referred to herein as a “uGPU tile”, on the screen are stored in the locally connected memory of a particular die such that the rendering of that rectangular area by an ROP located on that particular die (e.g., in respective GPCs, in memory partition units, etc. on the die) can proceed without any, or with substantially reduced amount of, data being read by the particular die over the C2C interface. This localization of the render targets that are subsequently rendered by ROP units is referred to herein as “ROP localization”.

Similarly, in some embodiments, certain data used by a compute shader executing on a particular die in a multi-chip GPU may be localized to the locally connected memory of that particular die, in order to reduce or eliminate messages and/or data exchanged over the C2C interface by the compute shader. For compute shaders that perform screen mapped operations, each compute shader cooperating thread arrays (CTA) that corresponds to a group of pixels on screen can be scheduled and memory arranged so that the threads in the CTA access the render targets that are stored in the locally connected memory of that particular die. As is also the case in ROP localization, a benefit of keeping the render target accesses for the compute shader local is that this reduces the C2C bandwidth consumed by the compute shader. This localization of render targets for compute shaders is referred to herein as “compute localization”. The term “render target localization” may refer to one or both ROP localization and compute localization.

The reduction of the C2C bandwidth consumed by ROP rendering and/or compute shaders can improve performance of the overall multi-chip GPU system as it means there is more bandwidth available for other traffic between the dies, such as, for example, for texture accesses. It can also reduce power requirements of the multi-chip GPU because the number of hops between dies to reach DRAM is reduced for render target accesses.

### Example Overall Hardware Architecture

One example multi-chip GPU implementation is built upon the concept of the uGPU described above to tackle the area concerns with a large chip using a single central xbar. As FIG. 4 shows, the GPU 400 is divided into plural (e.g., two) sub-groups (uGPUs). A central xbar is within each uGPU and the plural uGPUs are connected using point-to-point C2C 406 through LTC slice pairs (L2 caches) 408 and 410. In one embodiment, the two uGPUs 402 and 404 are fabricated on different dies 403 and 405. The multi-chip GPU 400 may be disposed on an interposer along with locally connected DRAM memory (e.g., HBM or GDDR 3D-stacked synchronous dynamic random-access memory (SDRAM)) 412 and 414 of the uGPUs 402 and 404, and, in some embodiments, a CPU 416. See for example U.S. Pat. No. 11,609,879. The interposer is disposed within a package that is in turn mounted and connected to a printed circuit board. The extra latency to go across the C2C when a GPC in one uGPU has to access data stored in the other uGPU, duplication of data in the LTCs (hence reduction of the useful cache capacity), and bandwidth limitations of the C2C interface can impact the overall performance of applications running on the multi-chip GPU 400.

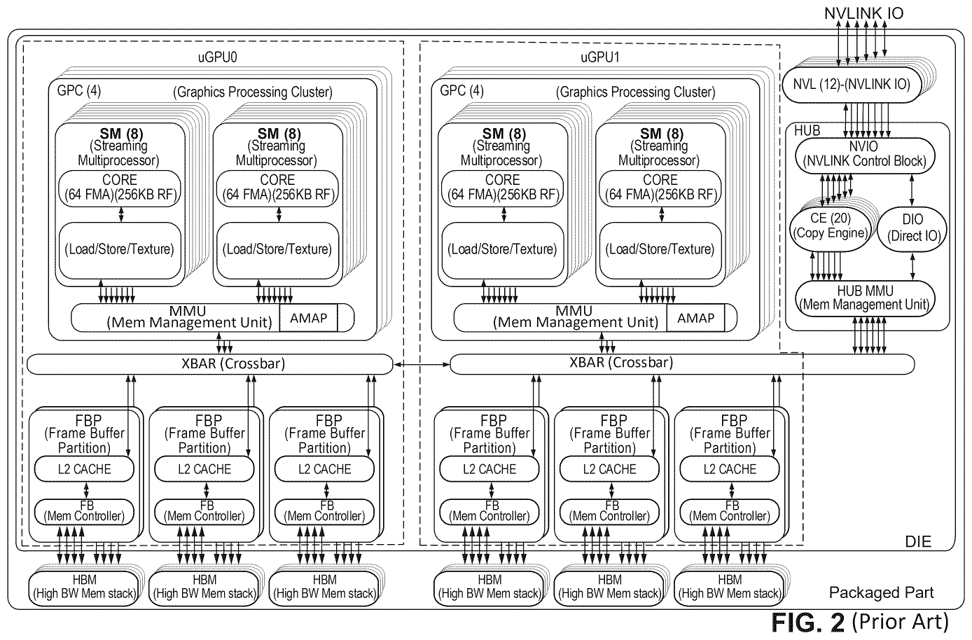

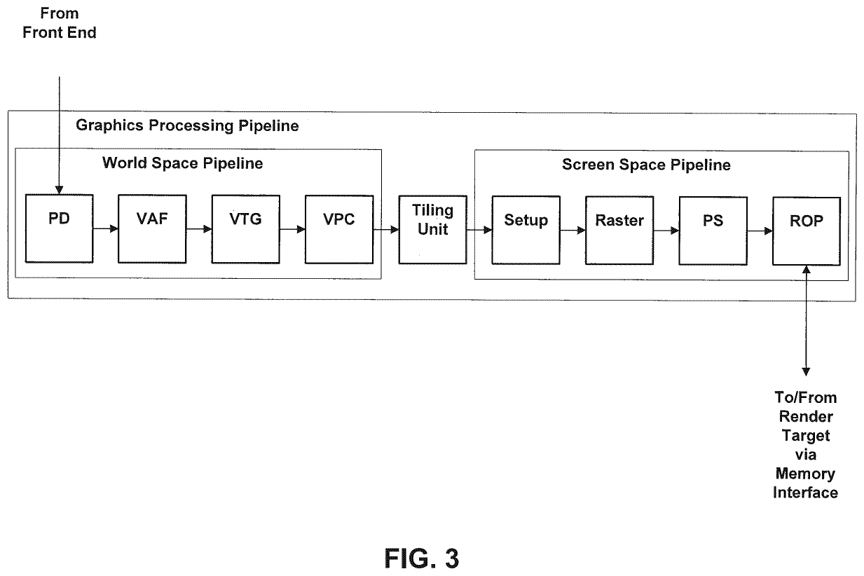

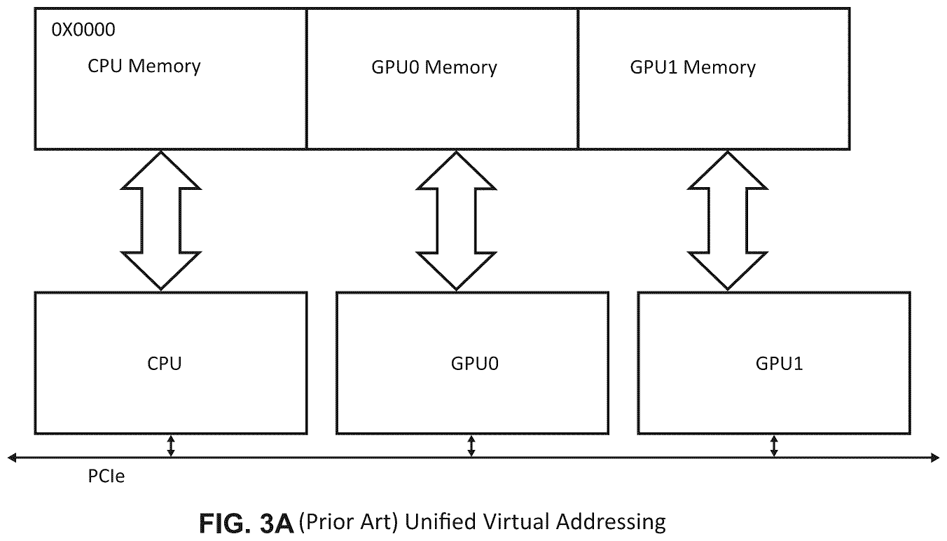

In some embodiments, the locally connected memory of the respective dies are configured to provide a unified view of memory as, for example, described in U.S. Pat. No. 11,893,653. An address mapping (AMAP) unit (hardware) in each uGPU provides an additional localized mapping to the uGPU so application data can be localized to a specific uGPU (see FIG. 2 and FIGS. 21-23 of U.S. Pat. No. 11,249,905 and associated description for more information on example MMU AMAPs). The AMAP may be configured to provide a stride view which maps all addresses into all memory units or devices across the full GPU address space (see FIG. 3A). In this view of memory, linearly increasing the memory address will stride across all of the DRAMs of the GPU memory system, thereby (evenly) distributing data across all of the individual DRAMs making up the memory for the overall GPU. See e.g., U.S. Pat. No. 11,182,309; US20130031328; U.S. Pat. No. 11,249,905. In some embodiments, the unified memory is interleaved with a fine granularity (e.g., of 2 KB) among the dies of the multi-chip GPU.

As already noted, a primary goal of embodiments of this disclosure is to reduce die to die traffic over the C2C connections between dies that make up a multi-chip GPU for the purpose of graphics workload rendering. This is accomplished primarily by introducing two capabilities: (1) Laying out in memory and 3D graphics pipeline rendering in a manner that allows ROP unit memory accesses to stay local to a die (ROP affinity or ROP localization) and (2) Enabling compute shader grids that are trivially mapped to screen space (e.g., where the thread to screen mapping is 1:1 and easy to determine) to similarly make memory accesses that are local to a die when reading and writing a screen-mapped render target surface (compute localization).

### ROP Localization

As already noted, ROP localization provides for the render targets corresponding to pixels in particular rectangular tile areas of the screen to be stored in the locally connected memory of a particular die in a multi-chip GPU such that the rendering of those rectangular areas by ROPs located on that particular die can proceed without any, or with substantially reduced amount of, data being read by the particular die over the C2C interface. Example embodiments provide for localizing render targets even when the render targets have multiple surfaces, e.g. color surface(s) and Z surfaces, that have different bit densities (i.e., different bits per pixel (BPP) sizes). In embodiments, the localization of render targets is achieved without requiring the changing of virtual address to physical address (VA->PA) mappings, or marking pages in a special way in the page table entries (PTEs). In example embodiments, hardware in the graphics pipeline can determine mapping to uGPU/die based on only (x,y) coordinates of the corresponding pixels. The determination by the MMU as to which uGPU a render target memory access is made to is independent of the bit density (BPP) of the surface. That is, the same set of PA bits determine uGPU independent of whether the surface is 8 bpp, 16 bpp, 32 bpp, 64 bpp, or 128 bpp.

One prior solution to distribute the rendering of a screen between multiple GPUs is Scalable Link Interface (SLI). See, e.g., U.S. Pat. No. 10,430,915. One form of SLI involves splitting a screen to be rendered by two or more GPUs, which is also called “split-frame rendering” (SFR). One key difference of embodiments of this disclosure with SFR is that in an SFR SLI system, software has to send draw commands for the entire frame to each GPU, and each GPU renders just the tiles it is allocated. This results in each GPU doing all world-space processing (i.e. vertex, tessellation, geometry shaders) and thus limits scalability. In contrast, embodiments of the present disclosure allow having a single front end to the GPU where world space processing is performed exactly once, and then the mapping from world space to screen space takes into account the localization of the render target via a checkerboard or checkerboard-like pattern mapping screen areas to particular dies in the multi-chip GPU. This results in better scalability.

Another key difference of example embodiments with SLI is that the render target surfaces can be allocated exactly once in both VA and PA spaces with the render target surfaces equally split between dies in the multi-chip GPU in example embodiments, whereas they are allocated in their entirety in VA space on each GPU in an SLI system. A third difference is that an SLI system involves many software complexities associated with handling two or more GPUs, whereas example embodiments can expose a multi-chip GPU system as a single large GPU to software, and hardware of the multi-chip GPU handles the distribution of rendering to uGPUs. A fourth difference with SLI is that in an SLI system, the display surface must be copied to a single GPU's memory in order to be displayed, whereas in example embodiments the display engine accesses the display surface from the respective dies or uGPUs and performs the same localization swizzle as the rendering units to access the correct portion of the image to display.

In some embodiments, a fixed interleaving of memory is configured at a fine granularity of 2 KB between each die of the multi-die GPU. In order to keep the same interleaving factor for any BPP size, the address in blocklinear space is swizzled as a function of the BPP by rearranging (e.g., rotating or swapping) higher bits in the blocklinear address. This swizzle is referred to herein as “localization swizzle”. After the localization swizzle is performed on an address of a surface, the MMU can compute which uGPU the localized surface memory address goes to by simply computing PA[11] XOR PA[12].

The localization swizzle capability may impose some alignment requirements in both virtual and physical address spaces. For example, some embodiments may have more stringent requirements for localized surface memory alignment in VA and PA space than for similar non-localized surfaces. In addition, surfaces may be required to have an even number of tiles in the width dimension (e.g., which can be satisfied by constraints on values of texHeader.tileWidthInGobs parameter) if they are to be localized. Embodiments may provide software the capability to control whether a surface is localized or not, and may require that all units that access localized surfaces are configured to keep or otherwise be able to access state to determine whether to apply the localization swizzle when accessing a particular surface.

In the graphics pipeline, after primitives have been world space processed (e.g. vertex shading), they are distributed to one or more screen pipelines that may reside in the same uGPU or different uGPUs, and this determination is done purely based on (x,y) coordinates of the primitives' vertices through the application of a checkerboard-like pattern (a perfect checkerboard pattern in the 2-chip GPU with 1 uGPU per die) that factors in the anti-aliasing (AA) factor. The checkerboard-like pattern enables distributing primitives in such a way that the underlying render target memory for tiles resides in the same uGPU on which they will be processed, thus achieving localization of render targets.

Thus, the combination of blocklinear memory swizzle and uGPU checkerboard aware distribution are key techniques that make render target localization and compute localization possible in embodiments of this disclosure.

It should be noted that although the embodiments described herein use a fine granularity of interleaving, at 2 KB granularity, which provides good performance for 3D rendering, embodiments are not limited to the 2 KB or other fine granularities of interleaving. Localization at a fine 2 KB granularity is more suitable for graphics rendering compared with coarse granularities (e.g., 32 MB) of interleaving memory in a multi-chip GPU. 3D rendering involves rendering to multiple surfaces with potentially different bit depths, e.g. color is 64 bits per pixel, Z at 32 bits per pixel and S at 8 bits per pixel. Some embodiments herein simultaneously render to those multiple surfaces and achieve localization for all surfaces. Additionally, some embodiments may provide good load balancing of screen space work between the dies (e.g., between the two dies in a 2-chip GPU) and thus interleaving at a coarse granularity (e.g., of 32 MB) would not be as suitable. Interleaving at a fine granularity can be important for good load balancing between the multiple dies.

Comparisons of framebuffer and stitch traffic (e.g., C2C traffic for frame rendering) between two GPU dies in a multi-chip GPU in a baseline scenario and in example embodiments show that in the baseline implementation without ROP localization, the total stitch traffic is greater than the framebuffer traffic. Since stitch bandwidth is generally expected to be less than framebuffer bandwidth, it can be expected that a multi-chip GPU system will be more stitch bandwidth limited than framebuffer limited. In example embodiments compared, with ROP localization enabled, the stitch traffic is reduced significantly. Thus, the ROP localization results in stitch traffic being less than framebuffer traffic, even without accounting for benefits associated with compute localization.

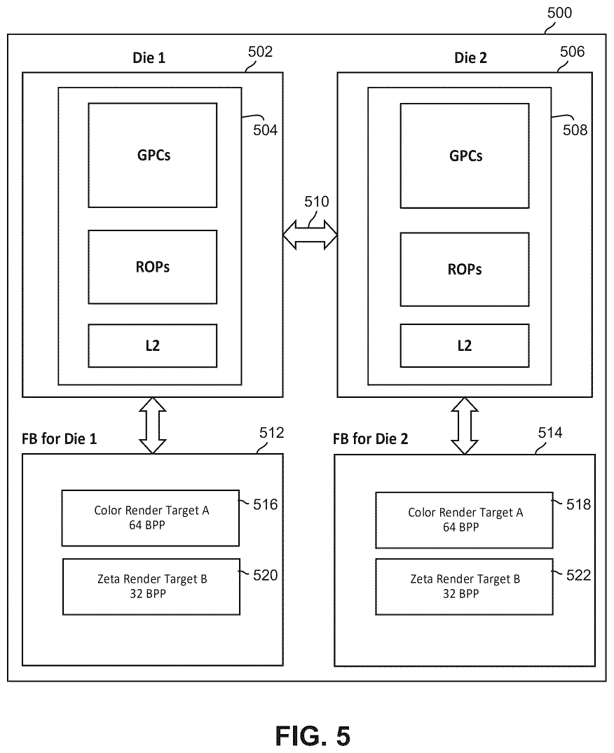

FIG. 5 illustrates a scenario where render targets are split between the framebuffers attached to the two dies in a multi-die GPU, according to some embodiments. Two-chip GPU 500 includes a first die 502 having a first uGPU 504 and a second die 506 having a second uGPU 508, and includes a C2C link 510 that communicatively connects uGPUs 504 and 508. Each uGPU has one or more graphics processing clusters (GPCs), one or more ROPs, and L2 cache. The first die 502 is connected to a first locally connected memory (first frame buffer) 512 and the second die 506 is connected to a second locally connected memory (second framebuffer) 514.

With ROP localization, the ROPs on each die operate mostly on portions of the render target surfaces that reside in the framebuffer connected to the same die. Each render target surface may have a different BPP. FIG. 5 illustrates ROP localization. Render targets are evenly split between the two framebuffers attached to the two dies. For example, color render target A 516 in the first framebuffer 512 comprises the color render target surface rendered by the ROPs on the first die 502, and color render target A 518 in the second framebuffer 514 comprises the color render target surface rendered by the ROPs on the second die 506. Whereas the color render target A surface is a 64 bpp surface, the z (zeta) render target B surface, which is localized similarly to the color render target, is a 32 bpp surface. As shown in the figure, surface portions 520 and 522 of the zeta render target B are stored in framebuffers 512 and 514, respectively, so that they are localized similarly to surface portions 516 and 518 of the color render target A. A goal for ROP localization is to make the ROP units on each die mostly operate on the regions of the various enabled render targets that are stored in the local framebuffer. Each render target can have a different BPP format. As shown in FIG. 5B, render targets are split between the framebuffers attached to the two dies. With ROP localization, the ROPs on each die operate mostly on portions of the render target surfaces that reside in the framebuffer connected to the same die.

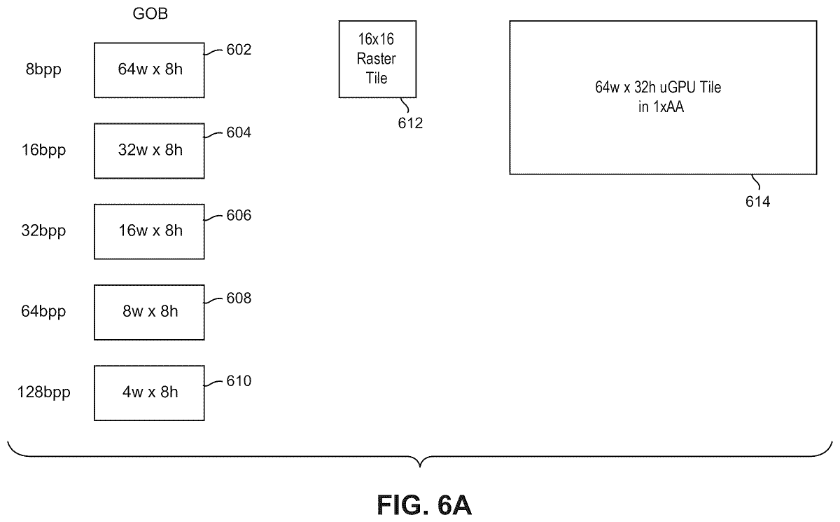

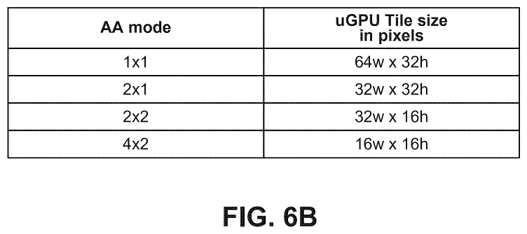

FIG. 6A illustrates a definition of group of bytes (GOB) as a function of BPP of a surface. In some embodiments, data such as, for example, 2D data is stored in memory in blocklinear format as an arrangement of blocks. In some embodiments, GOBs have a fixed size of 512 bytes, and a fixed height of 8 pixels. Thus, the 8 bpp GOB 602 has a height of 8 pixels and a width of 64 pixels, the 16 bpp GOB 604 has a height of 8 pixels and a width of 32 pixels, the 32 bpp GOB 606 has a height of 8 pixels and a width of 16 pixels, the 64 bpp GOB 608 has a height of 8 pixels and a width of 8 pixels, and the 128 bpp GOB 610 has a height of 8 pixels and a width of 4 pixels. As the figure shows, in example embodiments, the width of GOBs in pixels varies as a function of the BPP of the surface while the height is always fixed at 8 pixels such that each GOB contains 512 bytes. 2D data, such as, for example, surfaces etc., are typically stored in memory in blocklinear format in GOBs.

FIG. 6A shows a standard raster tile 612 which is used for distributing screen work (screen-mapped work) to GPCs. The standard raster tile may have a fixed size of 16 pixels wide×16 pixels high.

FIG. 6A also shows that a uGPU tile 614 is 64 pixels wide×32 pixels high in 1×AA mode. In embodiments, pixel work is distributed between uGPUs in the multi-chip GPU at the granularity of uGPU tiles. Although uGPU tiles have a fixed size of 64 samples wide×32 samples high when specified in samples, the size of uGPU tiles in pixels varies with the anti-aliasing (AA) mode as shown in the table of FIG. 6B.

The table of FIG. 6B shows 4 uGPU tile sizes as a function of the AA mode. The table illustrates that the height and/or width, in pixels, of uGPU tiles changes in accordance with the anti-aliasing level in the width direction or the height direction. For example, when no anti-aliasing is performed (i.e. 1×AA or 1×1 AA mode), the uGPU size in pixels at 64 pixels×32 pixels is identical to the fixed uGPU tile size in samples (i.e. 64 samples×32 samples), and when the AA mode is 4×2, the uGPU size in pixels at 16 pixels×16 pixels is different from the fixed uGPU tile size in samples.

### Requirements for Localization

As noted above, ROP localization may require that localized surfaces are aligned in certain manners and comprise even numbers of tiles in the width dimension. In some embodiments, driver software can allocate render target surfaces with 64 KB alignment in VA address space (with the exception of 128 BPP surfaces where the alignment requirement may be 128 KB). The alignment is required in the VA space because the localization swizzle occurs before the MMU which performs the VA to PA translation. The PA alignment may be at the page size of 64 KB. This may also apply to individual slices and finer mip levels (e.g., level of detail in texture surfaces). In some embodiments, driver software may be configured to allocate render target surfaces with 64 KB granularity since the addresses of pixels may be required to be rearranged (e.g. swizzled) within a 64 KB page.

In addition, surfaces may be required to have an even number of uGPU tiles in the width dimension if they are to be localized. Software can control whether a surface is localized or not, and all units that access localized surfaces are configured to maintain or access state to know whether to apply the localization swizzle when accessing a particular surface. In some embodiments, surfaces may be required to be allocated with an even number of uGPU tiles in the width dimension by padding, which means they must be allocated as a multiple of 128 samples in width.

In some embodiments, some surfaces may be localized and some other surfaces may not be localized. For example, 4 KB memory page mode may not be functionally compatible with localization in some configurations. In such environments, driver software cannot use 4 KB memory pages for surfaces that are to be localized. When 4 KB memory pages are used, the driver software may not set the localized bit via class methods. Driver software may mark a surface, which is intended to be localized, as being localized via a blocklinear state bit or other indicator that is associated with the surface.

In embodiments, the block height for localized surfaces can be set differently to 32, 16 or 8 GOBS. Block height 8 GOBS is applicable for all formats, whereas block heights of 32 and 16 GOBs are only applicable for selective formats.

The localization swizzle is described below for various surface bpps.

### BL to VA Swizzle as a Function of BPP

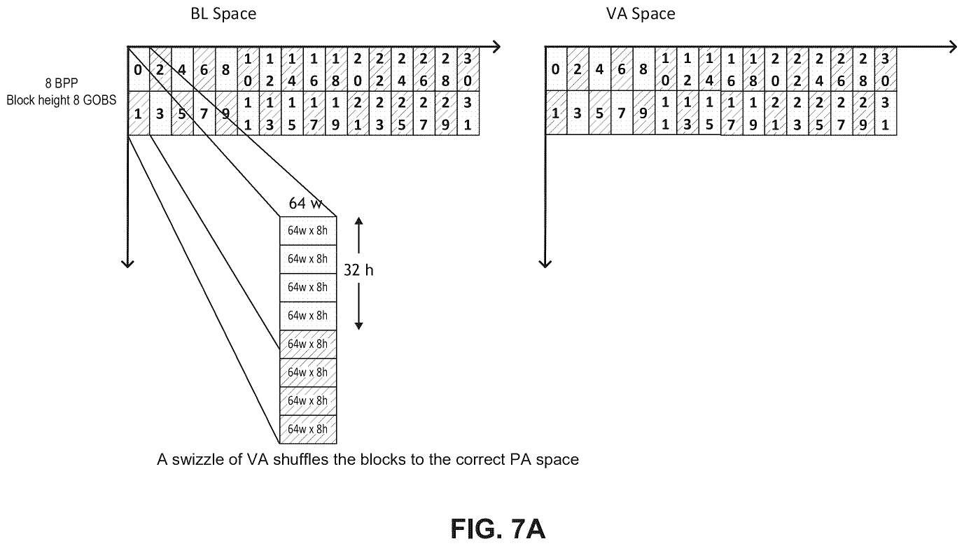

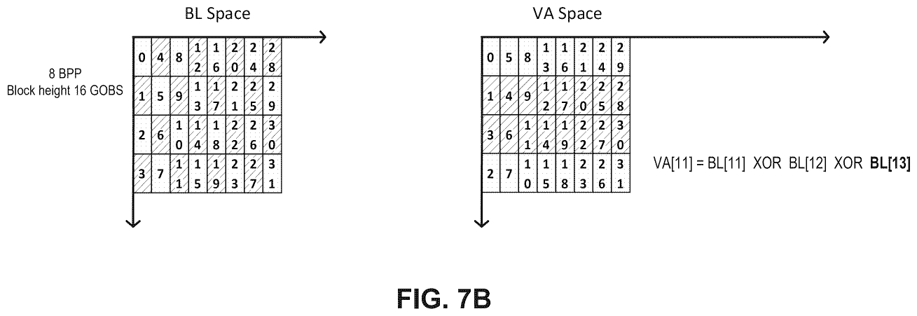

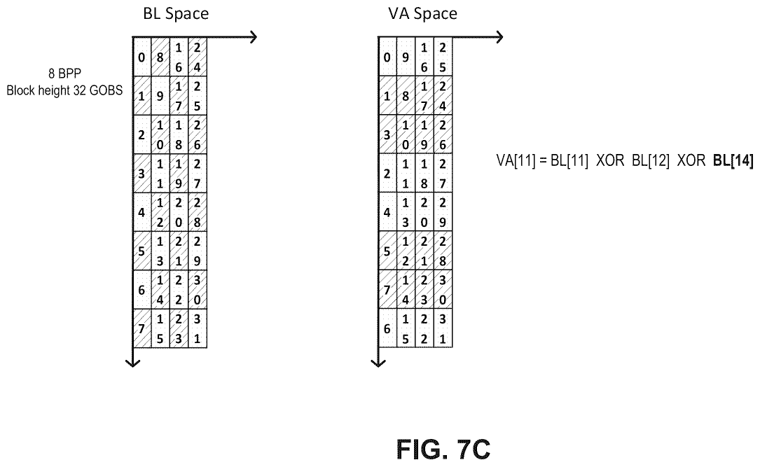

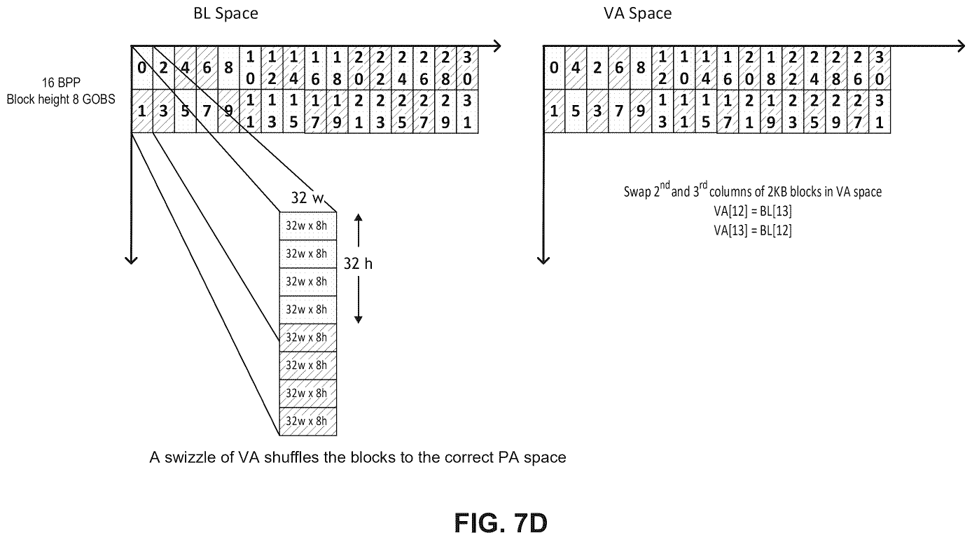

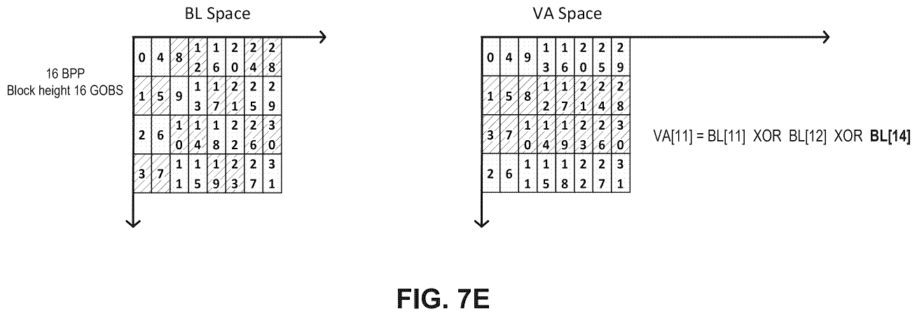

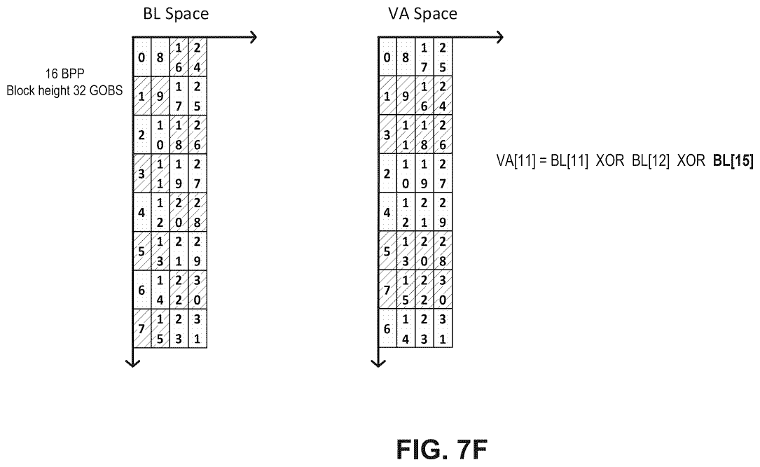

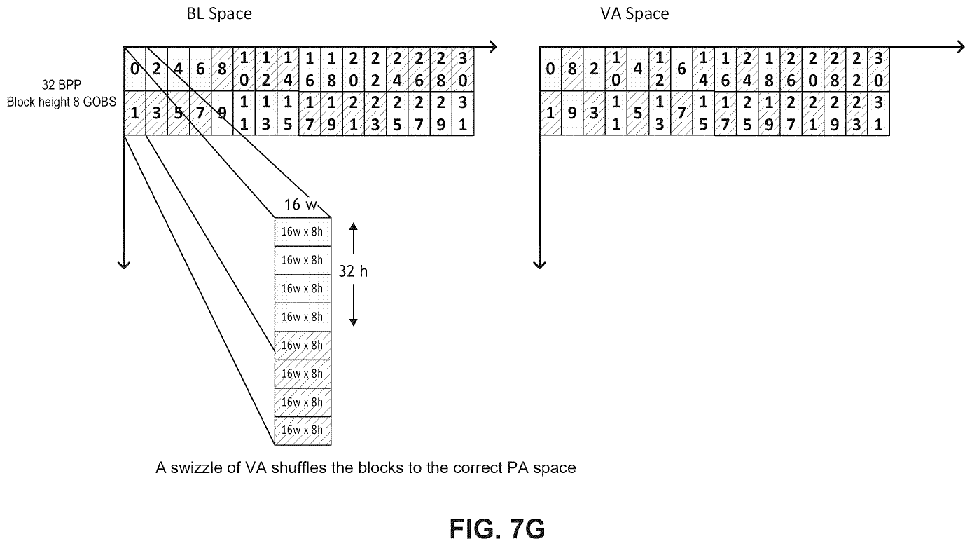

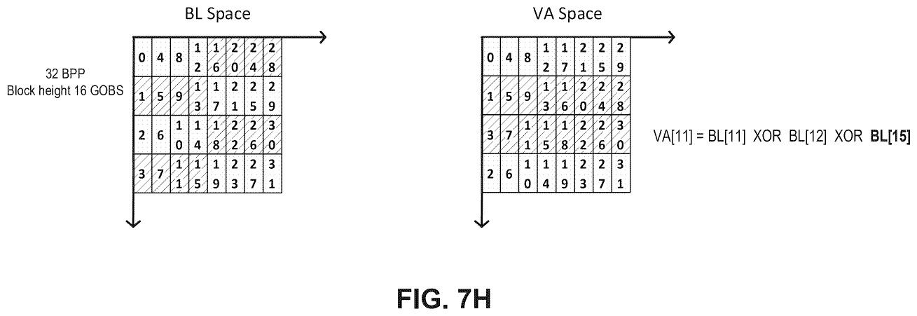

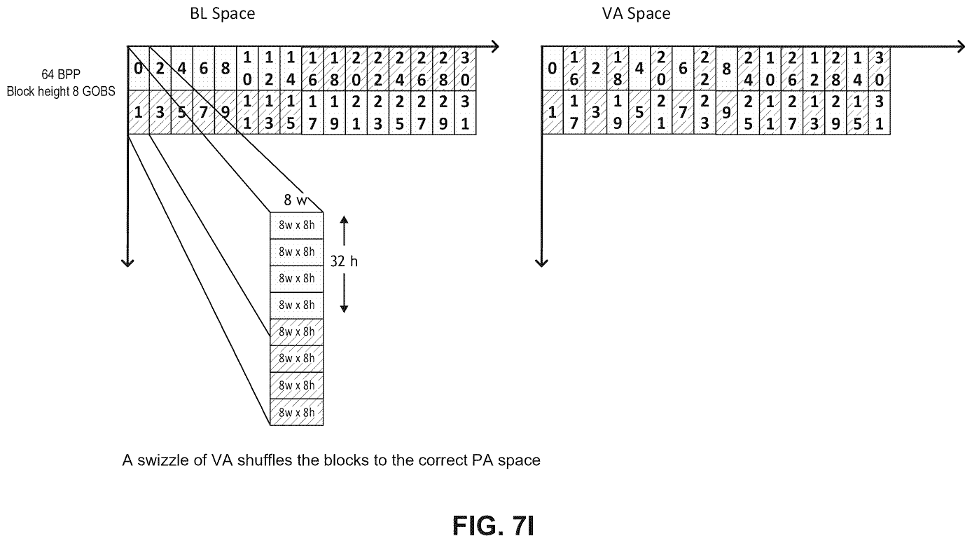

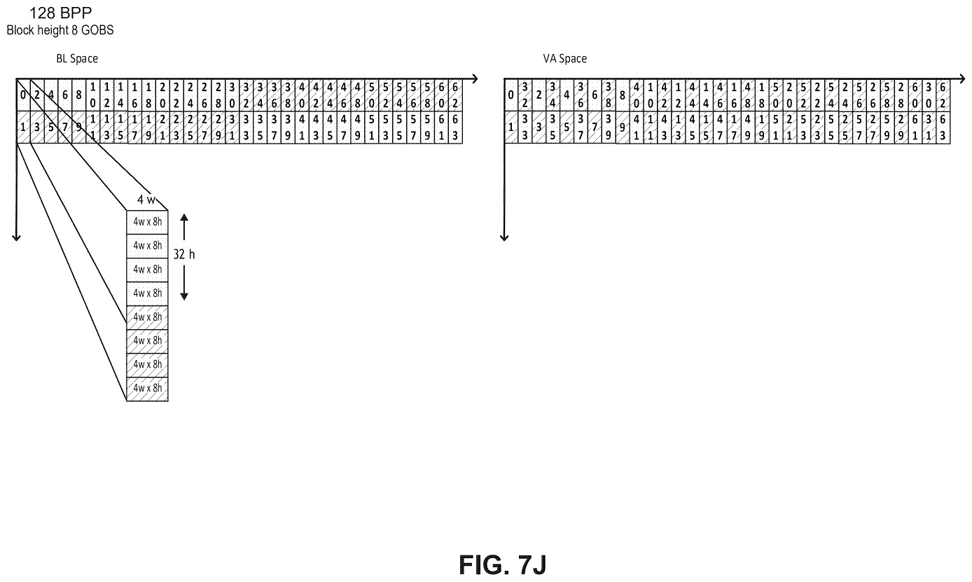

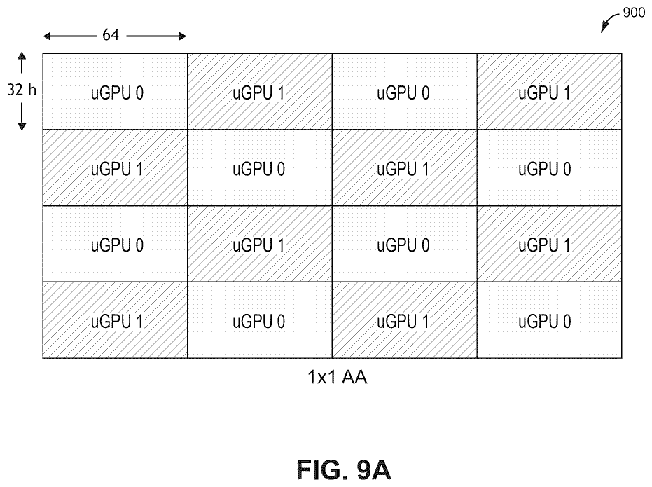

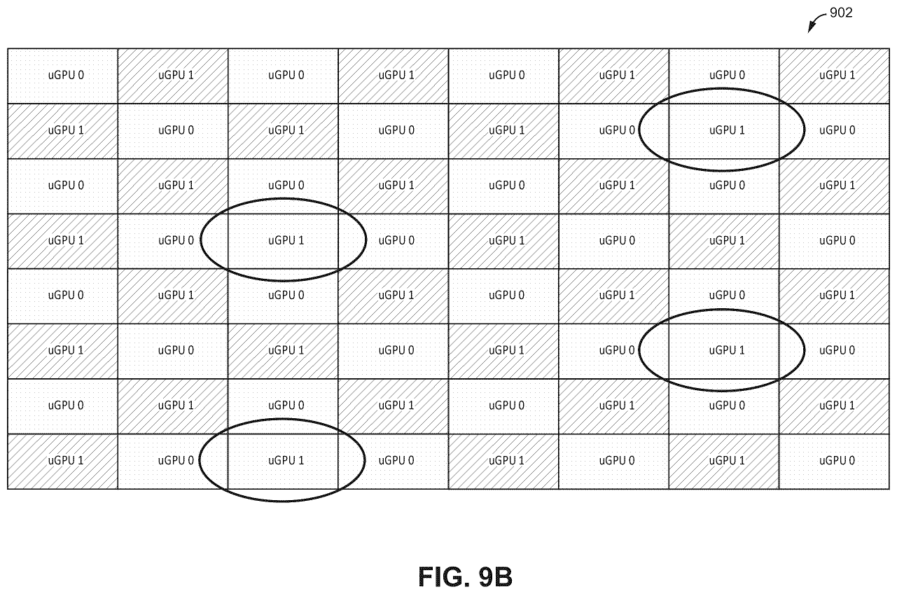

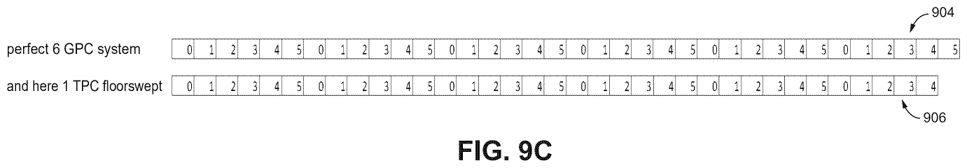

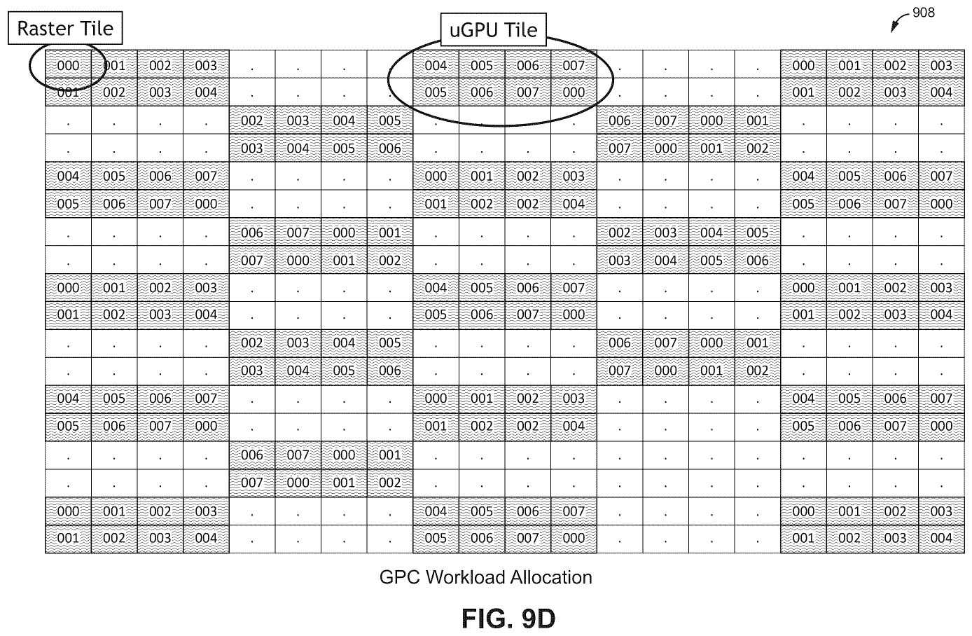

In some embodiments, every unit, including the CPU, that accesses a localized blocklinear surface performs a rearranging (e.g. swizzle) of the blocklinear virtual address (“BL address”) to obtain a corresponding virtual address, which is referred to herein as the “VA address”, that is then provided to the MMU which performs the VA to corresponding PA translation. This localization swizzle is necessary so that each uGPU tile fully maps to one uGPU or the other. That is, for any given uGPU tile (e.g. 64×32 pixel tiles in this example), the destination should be the same uGPU, regardless of the texel size (BPP), for every pixel in the tile. In this example, the destination uGPU is computed with the equation PA[11] XOR PA[12]. The localization swizzle is also necessary so that the uGPU tile mapping matches the screen-space checkerboard mapping to uGPU based on only screen (x,y) coordinates. FIGS. 7A-7J schematically illustrate example rearranging of blocks of GOBs from the BL address space to the VA address space achieved by rearranging (swizzling) BL addresses in a 2-chip GPU. The block arrangements shown are illustrated with two different fill patterns where the first fill pattern identifies blocks allocated to the first die of the 2-chip GPU, and the second fill pattern identifies blocks allocated to the second die. The arrangements on the left in BL address space shows how the blocks would be arranged if there is no localization, and the arrangements on the right in VA address space illustrate how the blocks are arranged with localization. The arrangements of the blocks in VA address space as shown on the right in each of the FIGS. 7A-7J together with the checkerboard (or checkerboard-like) allocations of the screen space as shown, for example, in FIGS. 9A-9B, enable the localizing of render targets to reduce the use of C2C bandwidth for rendering operations.

FIG. 7A shows an example VA swizzle for 8 BPP surfaces with block height of 8 GOBs. As illustrated, at 8 bpp, each 64×64 pixel block is made up of 8 GOBs (as noted above, each GOB has a height of 8 pixels).

For 8 BPP surfaces with block height of 8 GOBs, no swizzle is applied to the blocks i.e. VA=BL address. This is because the uGPU tiles that are 64×32 pixels exactly match the 2 KB interleaving between uGPUs. For example, a 2048 byte (i.e., 2 KB) slice of memory interleaved to a die exactly corresponds to 2048 pixels when each pixel is 8 bpp. Thus, the block layout in the BL address space as shown on the left is identical to the block layout in the VA address space as shown on the right. This requires 8 KB alignment in VA space.

FIG. 7B shows a VA swizzle for 8 BPP with block height of 16 GOBs. When block height is 16 GOBs, the 8 bpp swizzle is defined as:

$$\begin{matrix}VA = BL \\ VA [ 11 ] = BL [ 11 ] XOR BL [ 12 ] XOR BL [ 13 ] .\end{matrix}$$

FIG. 7C shows a VA swizzle for 8 BPP surfaces with block height of 32 GOBs. When block height is 32 GOBs, the 8 bpp swizzle is defined as:

$$\begin{matrix}VA = BL \\ VA [ 11 ] = BL [ 11 ] XOR BL [ 12 ] XOR BL [ 14 ] .\end{matrix}$$

FIG. 7D shows a VA swizzle for 16 BPP surfaces with block height of 8 GOBs. For 16 BPP surfaces with block height of 8 GOBs, the swizzle is defined as:

$$\begin{matrix}VA = BL \\ VA [ 12 ] = BL [ 13 ] \\ VA [ 13 ] = BL [ 12 ] .\end{matrix}$$

Note that at 16 BPP, the width of the GOB is 32 pixels (height is the same 8 pixels) and therefore 2 blocks of 8 GOBs each are required for a uGPU tile of 64×32 pixels. This can be seen in the arrangement on the left in the BL address space where sub blocks (each of 4 GOBs) 0 and 2 intended for uGPU 0 are next to each other and sub blocks 1 and 3 intended for uGPU 1 are next to each other. As shown on the right in the VA address space arrangement, sub blocks 0 and 2 are separated. In effect, as can be seen by comparing the block layout in the BL address space on the left and the VA address space on the right, every second and third columns of 2 KB blocks are swapped in the VA space. After the swizzle, each 2 KB block of data is interleaved between the two uGPUs so that checkerboard or checkerboard-like patterns of screen surface allocations to the respective dies correctly localizes render targets to each die, and each uGPU tile resides entirely on one uGPU (i.e. in the locally connected memory of that uGPU) or the other. This requires 16 KB alignment in VA space.

FIG. 7E shows a VA swizzle for 16 BPP with block height of 16 GOBs. For 16 BPP surfaces with block height of 16 GOBs, the swizzle is defined as:

$$\begin{matrix}VA = BL \\ VA [ 11 ] = BL [ 11 ] XOR BL [ 12 ] XOR BL [ 14 ] .\end{matrix}$$

FIG. 7F shows a VA swizzle for 16 BPP surfaces with block height of 32 GOBs. For 16 BPP surfaces with block height of 32 GOBs, the swizzle is defined as:

$$\begin{matrix}VA = BL \\ VA [ 11 ] = BL [ 11 ] XOR BL [ 12 ] XOR BL [ 15 ] .\end{matrix}$$

FIG. 7G shows a VA swizzle for 32 BPP surfaces with block height of 8 GOBs. For 32 BPP surfaces with block height of 8 GOBs, the swizzle is defined as:

$$\begin{matrix}VA = BL \\ VA [ 12 ] = BL [ 14 ] \\ VA [ 13 ] = BL [ 12 ] \\ VA [ 14 ] = BL [ 13 ] .\end{matrix}$$

Again, after the swizzle each 2 KB block of data is effectively interleaved between the two uGPUs. After the swizzle, each 2 KB block of data is interleaved between the two uGPUs so that checkerboard or checkerboard-like patterns of screen surface allocations to the respective dies correctly localizes render targets to each die, and each uGPU tile resides entirely on one uGPU or the other. This requires 32 KB alignment in VA space.

FIG. 7H shows a VA swizzle for 32 BPP surfaces with block height of 16 GOBs. For 32 BPP surfaces with block height of 16 GOBs, the swizzle is defined as:

$$\begin{matrix}VA = BL \\ VA [ 11 ] = BL [ 11 ] XOR BL [ 12 ] XOR BL [ 15 ] .\end{matrix}$$

This requires 64 KB alignment in VA space.

FIG. 7I shows a VA swizzle for 64 BPP surfaces. For 64 BPP surfaces, the swizzle is defined as:

$$\begin{matrix}VA = BL \\ VA [ 12 ] = BL [ 15 ] \\ VA [ 13 ] = BL [ 12 ] \\ VA [ 14 ] = BL [ 13 ] \\ VA [ 15 ] = BL [ 14 ] .\end{matrix}$$

This requires 64 KB alignment in VA space.

FIG. 7J shows a VA swizzle for 128 BPP surfaces. For 128 BPP surfaces, the swizzle is defined as:

$$\begin{matrix}VA = BL \\ VA [ 12 ] = BL [ 16 ] \\ VA [ 13 ] = BL [ 12 ] \\ VA [ 14 ] = BL [ 13 ] \\ VA [ 15 ] = BL [ 14 ] \\ VA [ 16 ] = BL [ 15 ] .\end{matrix}$$

This requires 128 KB alignment in VA space.

As shown in FIGS. 7A-7J, the swizzle in embodiments is purely a function of BPP of the surface. The swizzle may be implemented when a blocklinear surface is localized, even if the GPU is a single-die GPU.

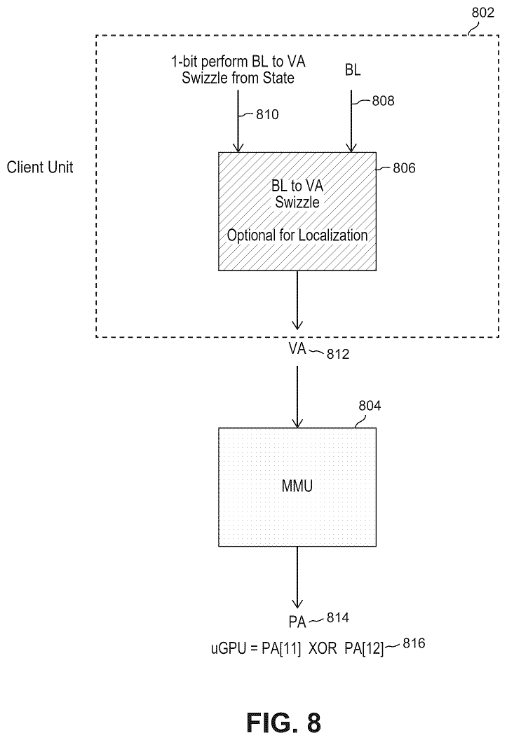

FIG. 8 is a block diagram of a localization swizzle that may be required to be implemented in hardware or in software in client units 802 that requires access to localized surfaces, and the MMU 804 operation to determine the uGPU. The client units 802 may include any of a ROP, load store unit (LST), copy engine, or any other client that accesses surfaces in the multi-chip GPU. FIG. 8 functionality may be implemented in hardware, software, or a combination thereof.

FIG. 8 illustrates that an additional BL to VA swizzle 806 (e.g., as shown in any one of FIGS. 7A-7J) is needed for accessing localized blocklinear surfaces. The BL to VA swizzle 806 unit may take as input the BL address 808 of a surface and a state indicator 810 indicating whether or not the surface is a localized surface. If the state indicator 810 is set indicating that the surface is a localized surface, then the swizzle 806, as shows, for example, in any of FIGS. 7A-7J, is performed on the BL address 808 and a swizzled VA 812 is provided as input to the MMU 804 that performs the VA to PA lookup based on the swizzled VA 812. The uGPU can be determined based on the relationship 816 of the selected set of bits in the PA 814 that is output by the MMU 804.

Software may control the state indicator 810, which may be a bit, to selectively localize only certain surfaces. For example, software may control this bit to localize color or z-surfaces because that would drastically reduce the C2C bandwidth usage for the corresponding ROP rendering, and to not localize surfaces such as texture surfaces which are unlikely to yield a significant reduction in C2C bandwidth usage. In situations where the driver cannot guarantee or confirm certain alignments in VA space as required for a particular surface (e.g., 128 bpp surface that requires 128 KB alignment) too, the state indicator 810 can be used to ensure that that particular surface is stored without localization.

### Surface Width Padding

Localized surfaces may require to be allocated with an even number of uGPU tiles in the width dimension. Since uGPU tiles are always 64 samples wide×32 samples high, this means (for a 2 uGPU design) the width each localized surface must be a multiple of 128 samples. This can be accomplished by padding the width. The actual width of the surface remains the same. This may be necessary to achieve a checkerboard pattern in the memory layout of the surface and thus match the work distribution, which is also a checkerboard pattern under ideal circumstances.

MMU Mapping to uGPU

The MMU may have a single finely interleaved mode (e.g., 2 KB interleaving) which applies to all accesses. The interleave granularity may be 2 KB. In some embodiments, the MMU takes as input a VA address and translates (e.g., looks up) the VA address to a corresponding PA. The MMU can identify which uGPU a physical address maps to as follows:

uGPU=PA[11] XOR PA[12].

As noted above, the VA address input to the MMU, in the case of a localized surface (i.e., a surface comprising localized render targets), is obtained by performing a localization swizzle on the corresponding BL address.

FIG. 9A illustrates a mapping to uGPU from (x,y) screen coordinates. The ideal mapping from screen (x,y) coordinates to uGPU is a perfect checkerboard as shown in the mapping 900. This applies to a system that has an equal number of GPCs in each uGPU, and is thus perfectly balanced. As noted earlier, the uGPU tile size is a function of AA mode, where uGPU tiles get proportionately smaller in pixels as a function of AA factor in each of X and Y dimensions. FIG. 9A is an illustration of a mapping 900 from screen (x,y) coordinates to uGPU in a system with equal number of GPCs in each uGPU in 1×AA mode. An example mapping from the (x, y) coordinates to the uGPU may be: uGPU=((X>>(6-Log₂(AA_X))) & 0x1) XOR ((Y>>(5−Log₂(AA_Y))) & 0x1). The driver may program AA_Y and AA_X, which represent the anti-aliasing level in the Y and X directions, respectively, based on the AA mode.

In a system where each uGPU has a different number of GPCs, it becomes desirable to tradeoff localization against load balancing. For example, if better load balancing is desired, more uGPU tiles can be assigned to the uGPU that has more GPCs. Thus, there may be a need to have more flexibility in assignment of uGPU tiles to uGPU resources. FIG. 9B illustrates a possible mapping 902 of work in a system where uGPU 0 has more DPCs than uGPU 1. It should be noted that the mapping is represented by the background fill in each rectangle, and not by the label in each cell (which shows the default checkboard assignment). As can be seen, it is mostly a checkerboard with some uGPU tiles flipped to work on uGPU 0 (i.e., the circled uGPU tiles are flipped from the default checkerboard assignment of uGPU 1 to be processed by uGPU 0).

Interaction with GPC Mapping

Each uGPU is configured to have its own GPC mapping table which is sized to exactly match the number of DPCs in that uGPU. Examples of such tables are shown in FIG. 9C. FIG. 9C shows two examples 904 and 906 of GPC mapping tables which is per uGPU in raster. The table is sized to the number of DPCs in a uGPU. Each entry represents the mapping of one raster tile to a GPC. The table is typically rotated by some number of entries on consecutive raster tile rows.

As shown in FIG. 9D, the GPC mapping table for each uGPU is mapped inside the uGPU tiles that are owned by that uGPU. The uGPU tile ownership is defined by a uGPU checkerboard ownership table discussed such as that shown in FIG. 9A or FIG. 9B. This ensures the expected distribution of work across GPCs in a given uGPU can be achieved.

As shown in FIG. 9D in the uGPU checkerboard ownership table 908, the raster tile to GPC mapping for each uGPU tile may be specified. Each small square in FIG. 9D represents a raster tile and the number shown in the center of each small rectangle represents the GPC to which it is mapped. The shaded rectangles, each of which comprises a plurality of small rectangles (8 in the illustrated example), represent uGPU tiles. The GPC mapping for each uGPU is defined by a one dimensional table sized for number of GPCs in the uGPU, and which is typically shifted from one row of raster tiles to the next. This mapping to GPCs is applied only to raster tiles that reside inside checkerboard tiles owned by the same uGPU as shown in FIG. 9D.

### Compute Localization for Screen Mapped Grids

Similar concepts as applied in localizing render targets for ROP rendering described above, can be applied to localize compute work. Sometime compute work can be mapped to a screen very much like a fragment shader or pixel shader maps to the screen. In this case too we can localize in the same way. Some embodiments provide for a subset of compute work that can be trivially mapped to screen space, e.g., each compute thread maps 1:1 to (X, Y) screen coordinates, to be localized. In such workloads, the write traffic can be localized. In addition, since such compute work typically consumes as input render targets such as g-buffers from previous graphics rendering passes, by making the compute CTAs run where the data resides locally, the texture read traffic across the C2C stitch interface can be reduced.

For example, when rendering a frame, the 3D part of the frame may generate a buffer (g-buffer) in memory. This buffer holds attributes for each pixel on the screen. In a second later pass over the frame, a compute shader can read the g-buffer data for a particular pixel and output (e.g., after a lighting calculation) a new color/different render target for the same pixel. In this operation, the compute shader reads data of a specific pixel and writes to a different surface but the same pixel. Similar to how pixel shaders have one thread to one pixel mapping, compute shaders can also have the same mapping of one thread to one pixels.

### Example Process Render Target Localization

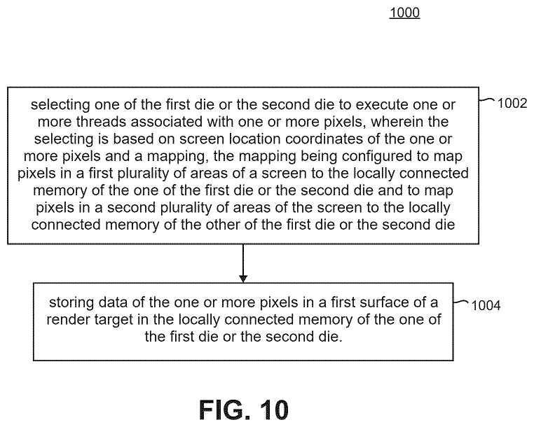

FIG. 10 shows a flowchart of a method 1000 for render target localization in a multi-chip GPU, in accordance with some embodiments of the present disclosure. Method 1000 is performed in a multi-chip GPU, such as, for example, the multi-chip GPU 400 of FIG. 4. The multi-chip GPU includes a first processor disposed on a first die, a second processor disposed on a second die, and a chip-to-chip communication interface connecting the first die and the second die. The multi-chip GPU enables access by each of multiple processors of the multi-chip GPU to each other's locally connected memory via the chip-to-chip interface. In some embodiments, the multi-chip GPU is configured to use a unified memory in which the first processor and the second processor can each access the locally connected memory of the other. The unified memory may be interleaved, for example, in a fine-interleaving (e.g., 2 KB) of slices between the locally connected memory of the first die and the locally connected memory of the second die.

As noted above, example embodiments reduce the chip-to-chip interface bandwidth consumption for rendering. The reduction of the bandwidth use is achieved by configuring a first subset of rectangular tile areas (e.g. uGPU tiles) of the screen to be rendered by the rendering components (e.g., ROP) on the first die, and a second subset of rectangular tile areas (e.g. uGPU tiles) to be rendered by the rendering components (e.g., ROP) in the second die. The parts of render targets, such as, for example, surfaces, that correspond to the first subset of rectangular tile areas are stored in the locally connected memory of the first die, and the parts of the render targets that correspond to the second subset of rectangular tile areas are stored in the locally connected memory of the second die. Additionally, work items that render that first subset of rectangular tile areas are executed on the first die, and work items that render the second subset of rectangular tile areas are executed on the second die. By this, the rendering of each rectangular tile area is localized so that data accesses across the chip-to-chip interface is eliminated or at least substantially reduced thereby freeing more of the chip-to-chip interface bandwidth for use by other tasks.

Operation 1002 may be performed when one of the processors in the multi-chip GPU (e,g. one of the uGPU in the multi-chip GPU 400), during the running of an application, distributes work (e.g., graphics or compute threads/thread arrays). At 1002, one of the first die or the second die is selected to execute one or more threads associated with one or more pixels on the screen. The selecting is based on screen location coordinates of the one or more pixels and a mapping. The mapping is configured to map pixels in the first plurality of rectangular tile areas of the screen to the locally connected memory of one of the first die or the second die and to map pixels in the second plurality of rectangular tile areas of the screen to the locally connected memory of the other of the first die or the second die. In the event that the multi-chip GPU is balanced in that the first die and the second die have similar processing capabilities, the mapping may be a perfect checkerboard pattern (e.g., FIG. 9A) of the first subset of the rectangular tiles and a second subset of the rectangular tiles.

The selection can be performed by performing one or more arithmetic operations (e.g., bit-wise shift operations) on the 2D screen locations (e.g., x, y coordinates) of the pixels. The performed arithmetic operation may be based on the anti-aliasing level of the pixel. For example, the coordinates may be shifted different amounts based on the anti-aliasing levels of the pixel.

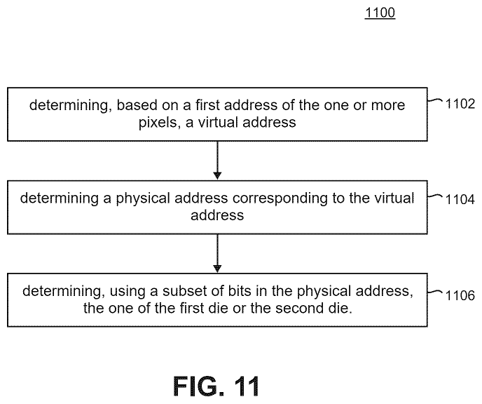

Operation 1004 may be performed when, for example, data is being written in the graphics pipeline. For example, after processing in the world-space portion of the graphics pipeline, the distribution of the output of the world space pipeline to the screen space pipelines can be performed in accordance with 1004. At 1004, data of the one or more pixels are stored in a first surface of a render target in the locally connected memory of the one of the first die or the second die. In some embodiments, the data of the one or more pixels is generated in a graphics pipeline executing on the one of the first die or the second die. In some embodiments, the data of the one or more pixels is generated by a compute shader executing on the first die or the second die. The flowchart of FIG. 11 further describes the storing.

In a further operation, based on the screen location of the one or more pixels, a cluster of processing units (e.g., a GPC) on the selected one of the first die or the second die are determined. The cluster of processing units is assigned a rendering tile to which the one or more pixels belongs.

In some embodiments, the first surface of the render target comprises data corresponding to pixels located in the first subset of the rectangular tile areas (e.g., uGPU tiles) and the second subset of rectangular tile areas. Each rectangular tile of the rectangular tile areas comprises an even number of rendering tiles in the width (X) dimension. Each processor tile may comprise an even number of rectangular blocks of data arranged in a blocklinear format.

In some embodiments, a second surface is stored in the render target corresponding to the one or more pixels to the locally connected memory of the one of the first die or the second die, wherein a bits per pixel metric of the second surface is different from that of the first surface.

In some embodiments, the render target in the locally connected memory of the one of the first die or the second die includes a plurality of surfaces with each surface storing a different bits per pixel metric. When a plurality of surfaces with different bits per pixel metrics are stored, method 1000 may further include processing, by a plurality of threads executing on the one of the first die or the second die, a rectangular tile of pixels that includes the one or more pixels by accessing respective surfaces of two different bits per pixel metrics in the locally connected memory of the one of the first die or the second die.

In some embodiments the first surface includes an associated localization indicator. The localization indicator may be a bit that, when set, indicates that the surface is localized, and if not set, indicates that the surface is not localized. Any processing, by the first processor or the second processor corresponding to the one of the first die or the second die, a rectangular tile of pixels that includes the one or more pixels by checking a status of the localization indicator of the first surface before accessing render targets in the first surface.

FIG. 11 shows a flowchart of a method 1100 for storing data of the one or more pixels in a first surface of a render target in the locally connected memory of the one of the first die or the second die, in accordance with some embodiments of the present disclosure. For example, method 1100 may be performed during operation 1004 shown in flowchart 1000.

At 1102, based on a first address (e.g., blocklinear address) of the one or more pixels, a virtual address is determined. The determining of the virtual address may be further based on a bits per pixel metric of the first surface. For example, whether to rearrange a subset of bits in the blocklinear address is determined based on the bits per pixel metric of the first surface, and, if it is determined to rearrange the subset of bits, the subset of bits in the blocklinear address is rearranged. FIGS. 7A-7J show some examples of swizzling the blocklinear address to obtain a corresponding virtual address.

The determining whether to rearrange a subset of bits in the blocklinear address may comprise, if the bits per pixel metric of the first surface is greater than a first level, determining to rearrange the second subset of bits. For example, for 8 bpp bits per pixel metric, no swizzling is necessary, whereas for higher bits per pixel metrics, localization swizzling is performed. Thus, the second subset of bits is determined based on the bits per pixel metric of the first surface.

In some embodiments, a unified memory of the multi-chip GPU may be interleaved over the locally connected memory of the first die and the locally connected memory of the second die, and the virtual address is in the unified memory.

At 1104 a physical address corresponding to the virtual address is determined. This may be performed in the MMU as a VA to PA mapping.

At 1106, determining the one of the first die or the second die is performed using a subset of bits in the physical address. The subset of bits is determined independently of a bits per pixel metric of the first surface.

The determining of the physical address and the determining the one of the first die or the second die are independent of a bits per pixel metric of the first surface. FIG. 8 illustrates the flow of operations, in some embodiments, to determining the uGPU that corresponds to a blocklinear address.

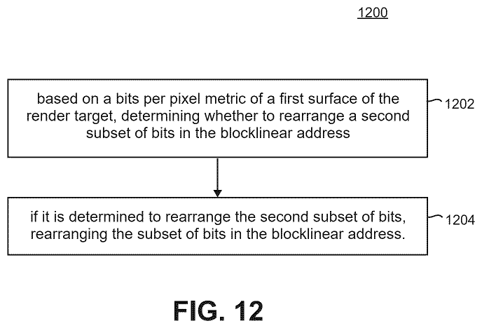

FIG. 12 shows a flowchart of a method 1200 for determining the virtual address at 1102 of flowchart 1100, according to some embodiments.

At 1202, based on a bits per pixel metric of the first surface of the render target, it is determined whether to rearrange the second subset of bits in the blocklinear address.

At 1204, if it is determined to rearrange the second subset of bits, the second subset of bits is rearranged in the blocklinear address.

Although example embodiments are described primarily in relation to multi-chip GPUs, some embodiments may comprise a system-on-chip (SoC) having a plurality of uGPUs that are disposed on the same chip. A respective locally connected memory of each of the plurality of uGPUs of the SoC may form a part of a unified memory in which each uGPU accesses the locally connected memory of any other uGPU over a communication interface. In such embodiments, the scheduling of work and arranging of memory for rendering certain surfaces may be configured so that accesses to the surfaces are mostly or entirely local to each uGPU in its locally connected memory. The localization to each uGPU can be performed in the same or similar manner as how localization to each die in multi-chip GPU embodiments is performed.

For example, single-chip SoC embodiments reduce the uGPU-to-uGPU interface bandwidth consumption for rendering. The reduction of the bandwidth use is achieved by configuring a first subset of rectangular tile areas (e.g. uGPU tiles) of the screen to be rendered by the rendering components (e.g., ROP) on the first uGPU, and a second subset of rectangular tile areas (e.g. uGPU tiles) to be rendered by the rendering components (e.g., ROP) in the second uGPU. The parts of render targets, such as, for example, surfaces, that correspond to the first subset of rectangular tile areas are stored in the locally connected memory of the first uGPU, and the parts of the render targets that correspond to the second subset of rectangular tile areas are stored in the locally connected memory of the second uGPU. Additionally, work items that render that first subset of rectangular tile areas are executed on the first uGPU, and work items that render the second subset of rectangular tile areas are executed on the second uGPU. By this, the rendering of each rectangular tile area is localized so that data accesses across the uGPU-to-uGPU interface is eliminated or at least substantially reduced thereby freeing more of the uGPU-to-uGPU interface bandwidth for use by other tasks.

### Example GPU Architecture

An example illustrative architecture of a chip/die in a multi-chip GPU described in relation to FIGS. 4-12, is described in accordance with some embodiments. The following information is set forth for illustrative purposes and should not be construed as limiting in any manner. Any of the following features may be optionally incorporated with or without the exclusion of other features described.

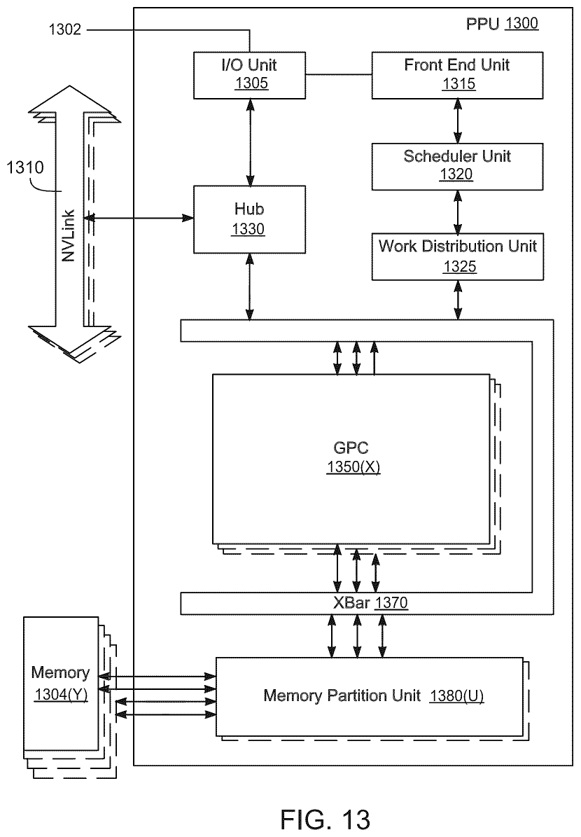

FIG. 13 illustrates a parallel processing unit (PPU) 1300 that may be included on a die of a multi-die GPU, in accordance with an embodiment. In an embodiment, the PPU 1300 is a multi-threaded processor that is implemented on one or more integrated circuit devices. The PPU 1300 is a latency hiding architecture designed to process many threads in parallel. A thread (e.g., a thread of execution) is an instantiation of a set of instructions configured to be executed by the PPU 1300. In an embodiment, the PPU 1300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 1300 may be utilized for performing general-purpose computations. In some other embodiments, PPU 1300 configured to implement large neural networks in deep learning applications or other high performance computing applications.

One or more PPUs 1300 may be configured to accelerate thousands of High Performance Computing (HPC), data center, and machine learning applications. The PPU 1300 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 13, the PPU 1300 includes an Input/Output (I/O) unit 1305, a front end unit 1315, a scheduler unit 1320, a work distribution unit 1325, a hub 1330, a crossbar (Xbar) 1370, one or more general processing clusters (GPCs) 1350, and one or more partition units 1380. The PPU 1300 may be connected to a host processor or other PPUs 1300 via one or more high-speed NVLink 1310 interconnect. The PPU 1300 may be connected to a host processor or other peripheral devices via an interconnect 1302. The PPU 1300 may also be connected to a memory comprising a number of memory devices 1304. In an embodiment, the memory 1304 may comprise a number of dynamic random access memory (DRAM) devices. The DRAM devices may be configured as a high-bandwidth memory (e.g., HBM or GDDR) subsystem, with multiple DRAM dies stacked within each device.

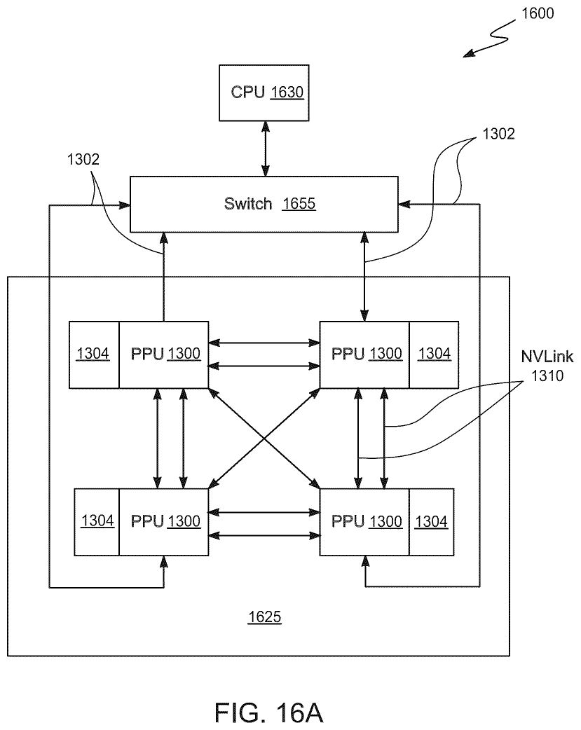

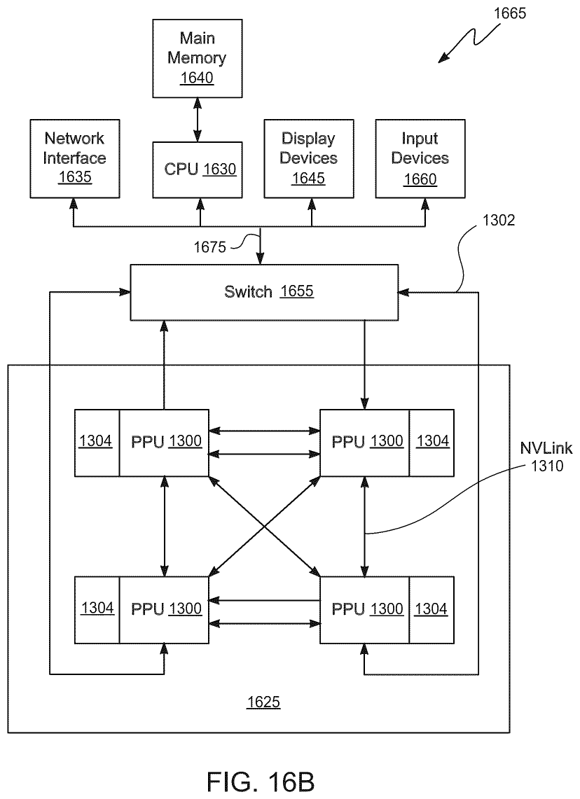

The NVLink 1310 interconnect enables systems to scale and include one or more PPUs 1300 combined with one or more CPUs, supports cache coherence between the PPUs 1300 and CPUs, and CPU mastering. Data and/or commands may be transmitted by the NVLink 1310 through the hub 1330 to/from other units of the PPU 1300 such as one or more copy engines, a video encoder, a video decoder, a power management unit, etc. (not explicitly shown). The NVLink 1310 is described in more detail in conjunction with FIG. 16A and FIG. 16B. However, the interconnect 1410 is not limited to using NVLink.

The I/O unit 1305 is configured to transmit and receive communications (e.g., commands, data, etc.) from a host processor (not shown) over the interconnect 1302. The I/O unit 1305 may communicate with the host processor directly via the interconnect 1302 or through one or more intermediate devices such as a memory bridge. In an embodiment, the I/O unit 1305 may communicate with one or more other processors, such as one or more of the PPUs 1300 via the interconnect 1302. In an embodiment, the I/O unit 1305 implements a Peripheral Component Interconnect Express (PCIe) interface for communications over a PCIe bus and the interconnect 1302 is a PCIe bus. In alternative embodiments, the I/O unit 1305 may implement other types of well-known interfaces for communicating with external devices.

The I/O unit 1305 decodes packets received via the interconnect 1302. In an embodiment, the packets represent commands configured to cause the PPU 1300 to perform various operations. The I/O unit 1305 transmits the decoded commands to various other units of the PPU 1300 as the commands may specify. For example, some commands may be transmitted to the front end unit 1315. Other commands may be transmitted to the hub 1330 or other units of the PPU 1300 such as one or more copy engines, a video encoder, a video decoder, a power management unit, etc. (not explicitly shown). In other words, the I/O unit 1305 is configured to route communications between and among the various logical units of the PPU 1300.

In an embodiment, a program executed by the host processor encodes a command stream in a buffer that provides workloads to the PPU 1300 for processing. A workload may comprise several instructions and data to be processed by those instructions. The buffer is a region in a memory that is accessible (e.g., read/write) by both the host processor and the PPU 1300. For example, the I/O unit 1305 may be configured to access the buffer in a system memory connected to the interconnect 1302 via memory requests transmitted over the interconnect 1302. In an embodiment, the host processor writes the command stream to the buffer and then transmits a pointer to the start of the command stream to the PPU 1300. The front end unit 1315 receives pointers to one or more command streams. The front end unit 1315 manages the one or more streams, reading commands from the streams and forwarding commands to the various units of the PPU 1300.

The front end unit 1315 is coupled to a scheduler unit 1320 that configures the various GPCs 1350 to process tasks defined by the one or more streams. The scheduler unit 1320 is configured to track state information related to the various tasks managed by the scheduler unit 1320. The state may indicate which GPC 1350 a task is assigned to, whether the task is active or inactive, a priority level associated with the task, and so forth. The scheduler unit 1320 manages the execution of a plurality of tasks on the one or more GPCs 1350.

The scheduler unit 1320 is coupled to a work distribution unit 1325 that is configured to dispatch tasks for execution on the GPCs 1350. The work distribution unit 1325 may track a number of scheduled tasks received from the scheduler unit 1320. In an embodiment, the work distribution unit 1325 manages a pending task pool and an active task pool for each of the GPCs 1350. The pending task pool may comprise a number of slots (e.g., 32 slots) that contain tasks assigned to be processed by a particular GPC 1350. The active task pool may comprise a number of slots (e.g., 4 slots) for tasks that are actively being processed by the GPCs 1350. As a GPC 1350 finishes the execution of a task, that task is evicted from the active task pool for the GPC 1350 and one of the other tasks from the pending task pool is selected and scheduled for execution on the GPC 1350. If an active task has been idle on the GPC 1350, such as while waiting for a data dependency to be resolved, then the active task may be evicted from the GPC 1350 and returned to the pending task pool while another task in the pending task pool is selected and scheduled for execution on the GPC 1350.

The work distribution unit 1325 communicates with the one or more GPCs 1350 via XBar 1370. The XBar 1370 is an interconnect network that couples many of the units of the PPU 1300 to other units of the PPU 1300. For example, the XBar 1370 may be configured to couple the work distribution unit 1325 to a particular GPC 1350. Although not shown explicitly, one or more other units of the PPU 1300 may also be connected to the XBar 1370 via the hub 1330.

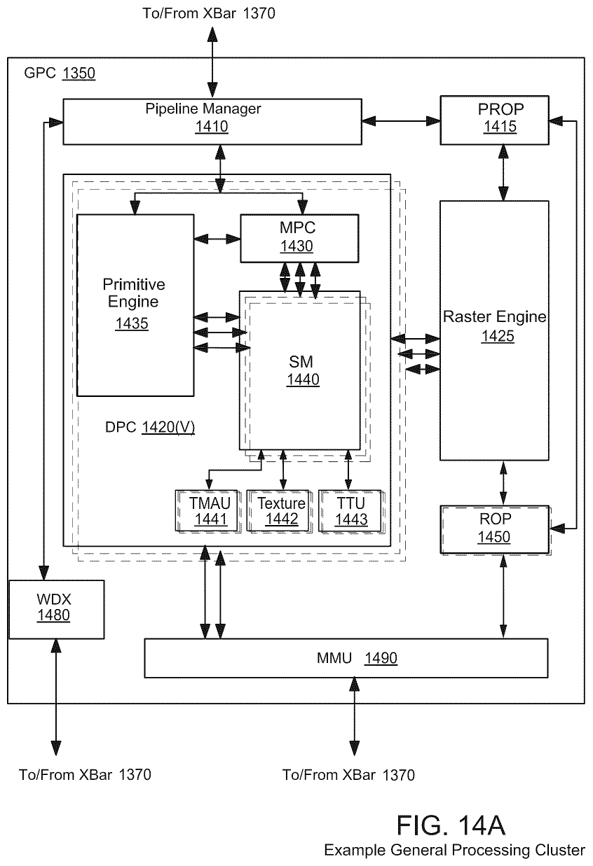

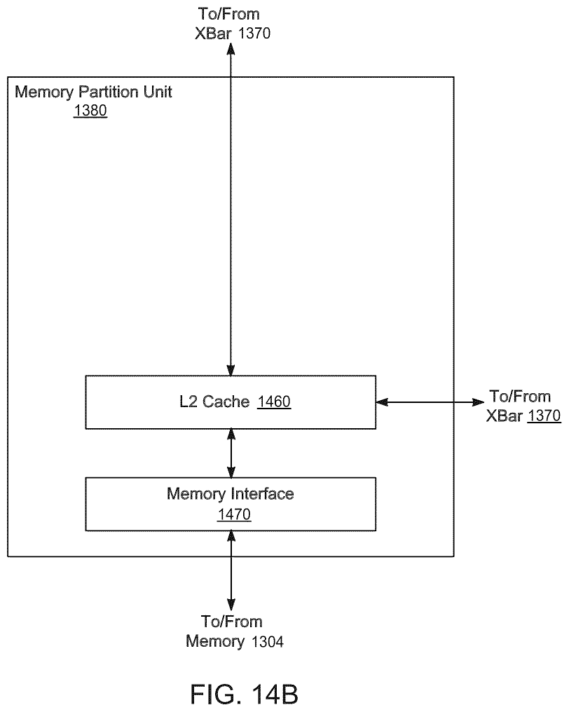

The tasks are managed by the scheduler unit 1320 and dispatched to a GPC 1350 by the work distribution unit 1325. The GPC 1350 is configured to process the task and generate results. The results may be consumed by other tasks within the GPC 1350, routed to a different GPC 1350 via the XBar 1370, or stored in the memory 1304. The results can be written to the memory 1304 via the partition units 1380, which implement a memory interface for reading and writing data to/from the memory 1304. The results can be transmitted to another PPU 1304 or CPU via the NVLink 1310. In an embodiment, the PPU 1300 includes a number U of partition units 1380 that is equal to the number of separate and distinct memory devices 1304 coupled to the PPU 1300. A partition unit 1380 will be described in more detail below in conjunction with FIG. 14B.

In an embodiment, a host processor executes a driver kernel that implements an application programming interface (API) that enables one or more applications executing on the host processor to schedule operations for execution on the PPU 1300. In an embodiment, multiple compute applications are simultaneously executed by the PPU 1300 and the PPU 1300 provides isolation, quality of service (QoS), and independent address spaces for the multiple compute applications. An application may generate instructions (e.g., API calls) that cause the driver kernel to generate one or more tasks for execution by the PPU 1300. The driver kernel outputs tasks to one or more streams being processed by the PPU 1300. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory (SMEM). Threads, cooperating threads and a hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety. The SMEM, according to some embodiments, is described in U.S. application Ser. No. 17/691,690, which is hereby incorporated in reference in its entirety.

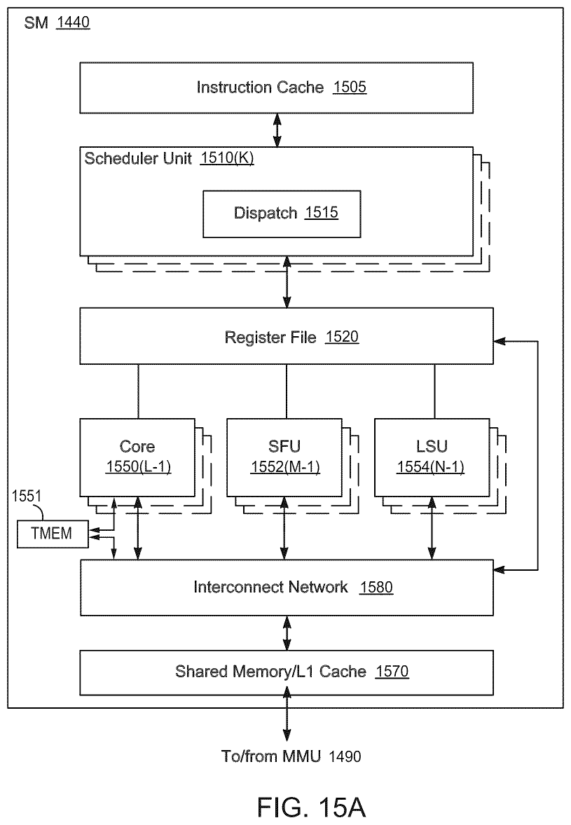

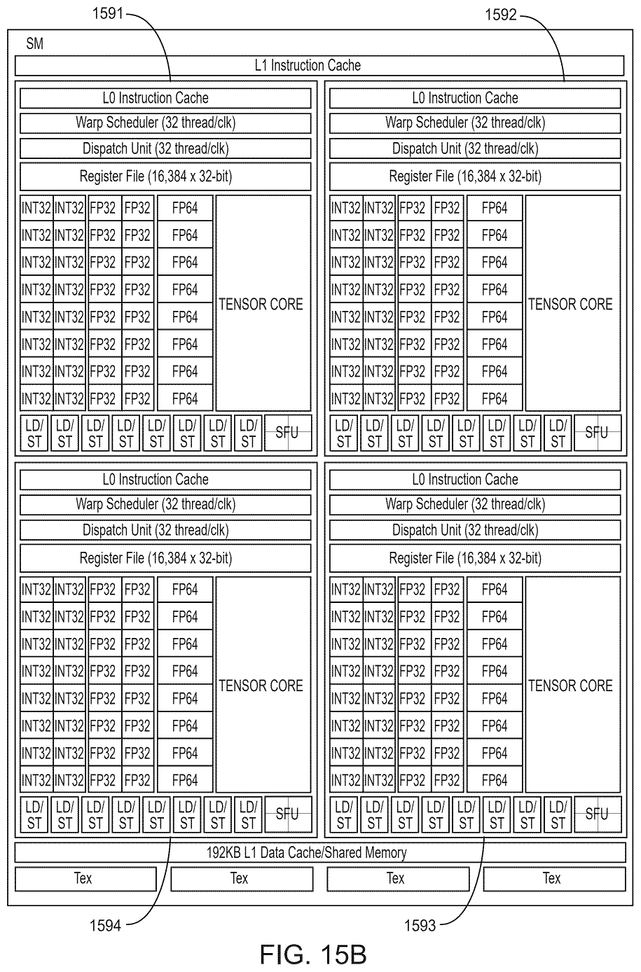

FIG. 14A illustrates a GPC 1350 of the PPU 1300 of FIG. 13, in accordance with an embodiment. As shown in FIG. 14A, each GPC 1350 includes a number of hardware units for processing tasks. In an embodiment, each GPC 1350 includes a pipeline manager 1410, a pre-raster operations unit (PROP) 1415, a raster engine 1525, a work distribution crossbar (WDX) 1580, a memory management unit (MMU) 1590, and one or more Data Processing Clusters (DPCs) 1520. It will be appreciated that the GPC 1350 of FIG. 15A may include other hardware units in lieu of or in addition to the units shown in FIG. 15A.

In an embodiment, the operation of the GPC 1350 is controlled by the pipeline manager 1410. The pipeline manager 1410 manages the configuration of the one or more DPCs 1420 for processing tasks allocated to the GPC 1350. In an embodiment, the pipeline manager 1410 may configure at least one of the one or more DPCs 1420 to implement at least a portion of a graphics rendering pipeline, a neural network, and/or a compute pipeline. For example, with respect to a graphics rendering pipeline, a DPC 1420 may be configured to execute a vertex shader program on the programmable streaming multiprocessor (SM) 1440. The pipeline manager 1410 may also be configured to route packets received from the work distribution unit 1325 to the appropriate logical units within the GPC 1350. For example, some packets may be routed to fixed function hardware units in the PROP 1415 and/or raster engine 1425 while other packets may be routed to the DPCs 1420 for processing by the primitive engine 1435 or the SM 1440.

The PROP unit 1415 is configured to route data generated by the raster engine 1425 and the DPCs 1420 to a Raster Operations (ROP) unit 1450. The illustrated ROP unit 1450 may comprise a plurality of ROP units. The PROP unit 1415 may also be configured to perform optimizations for color blending, organize pixel data, perform address translations, and the like.

Each DPC 1420 included in the GPC 1350 includes an M-Pipe Controller (MPC) 1430, a primitive engine 1435, and one or more SMs 1440. The MPC 1430 controls the operation of the DPC 1420, routing packets received from the pipeline manager 1410 to the appropriate units in the DPC 1420. For example, packets associated with a vertex may be routed to the primitive engine 1435, which is configured to fetch vertex attributes associated with the vertex from the memory 1304. In contrast, packets associated with a shader program may be transmitted to the SM 1440.

The SM 1440 comprises a programmable streaming processor that is configured to process tasks represented by a number of threads. Each SM 1440 is multi-threaded and configured to execute a plurality of threads (e.g., 32 threads) from a particular group of threads concurrently. In an embodiment, the SM 1440 implements a SIMT (Single-Instruction, Multiple-Thread) architecture where each thread in a group of threads (e.g., a warp) is configured to process a different set of data based on the same set of instructions. All threads in the group of threads execute the same instructions. In another embodiment, the SM 1440 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 1440 is described in more detail below in conjunction with FIG. 15A. FIG. 15B conceptually illustrates four subpartitions 1591-1594 implemented in an SM such as the SM shown in FIG. 15A, according to some embodiments.

The MMU 1490 provides an interface between the GPC 1350 and the partition unit 1380. The MMU 1490 may provide translation of virtual addresses into physical addresses, memory protection, and arbitration of memory requests. In an embodiment, the MMU 1490 provides one or more translation lookaside buffers (TLBs) for performing translation of virtual addresses into physical addresses in the memory 1304.

FIG. 14B illustrates a memory partition unit 1380 of the PPU 1300 of FIG. 13 in accordance with an embodiment. As shown in FIG. 14B, the memory partition unit 1380 includes a level two (L2) cache 1460, and a memory interface 1470. The memory interface 1470 is coupled to the memory 1304. Memory interface 1470 may implement 32, 64, 128, 1024-bit data buses, or the like, for high-speed data transfer. In an embodiment, the PPU 1300 incorporates U memory interfaces 1470, one memory interface 1470 per pair of partition units 1380, where each pair of partition units 1380 is connected to a corresponding memory device 1304. For example, PPU 1300 may be connected to up to Y memory devices 1304, such as high bandwidth memory stacks or graphics double-data-rate, version 5, synchronous dynamic random access memory, or other types of persistent storage.

In an embodiment, the memory interface 1470 implements an HBM2 memory interface and Y equals half U. In an embodiment, the HBM2 memory stacks are located on the same physical package as the PPU 1300, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 824 bits.

In an embodiment, the memory 1304 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 1300 process very large datasets and/or run applications for extended periods.

In an embodiment, the PPU 1300 implements a multi-level memory hierarchy. In an embodiment, the memory partition unit 1380 supports a unified memory to provide a single unified virtual address space for CPU and PPU 1300 memory, enabling data sharing between virtual memory systems. In an embodiment the frequency of accesses by a PPU 1300 to memory located on other processors is traced to ensure that memory pages are moved to the physical memory of the PPU 1300 that is accessing the pages more frequently. In an embodiment, the NVLink 1310 supports address translation services allowing the PPU 1300 to directly access a CPU's page tables and providing full access to CPU memory by the PPU 1300.

In an embodiment, copy engines transfer data between multiple PPUs 1300 or between PPUs 1300 and CPUs. The copy engines can generate page faults for addresses that are not mapped into the page tables. The memory partition unit 1380 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1304 or other system memory may be fetched by the memory partition unit 1380 and stored in the L2 cache 1460, which is located on-chip and is shared between the various GPCs 1350. As shown, each memory partition unit 1380 includes a portion of the L2 cache 1460 associated with a corresponding memory device 1304. Lower level caches may then be implemented in various units within the GPCs 1350. For example, each of the SMs 1440 may implement a level one (L1) cache. The L1 cache is private memory that is dedicated to a particular SM 1440. Data from the L2 cache 1460 may be fetched and stored in each of the L1 caches for processing in the functional units of the SMs 1440. The L2 cache 1460 is coupled to the memory interface 1470 and the XBar 1370.

The ROP unit 1450 performs graphics raster operations related to pixel color, such as color compression, pixel blending, and the like. The ROP unit 1450 also implements depth testing in conjunction with the raster engine 1425, receiving a depth for a sample location associated with a pixel fragment from the culling engine of the raster engine 1425. The depth is tested against a corresponding depth in a depth buffer for a sample location associated with the fragment. If the fragment passes the depth test for the sample location, then the ROP unit 1450 updates the depth buffer and transmits a result of the depth test to the raster engine 1425. Although the ROP unit 1450 is included within the GPC 1350 in FIG. 14A, in other embodiment, the ROP unit 1450 may be outside of the GPC 1350. For example, the ROP unit 1450 may reside in the memory partition unit 1380 or another unit.

FIG. 15A illustrates the streaming multiprocessor 1440 of FIG. 14A, in accordance with an embodiment. As shown in FIG. 15A, the SM 1440 includes an instruction cache 1505, one or more scheduler units 1510, a register file 1520, one or more processing cores 1550, one or more special function units (SFUs) 1552, one or more load/store units (LSUs) 1554, an interconnect network 1580, a SMEM/L1 cache 1570.

As described above, the work distribution unit 1325 dispatches tasks, or more specifically it dispatches one by one the CTAs that make up a task, for execution on the GPCs 1350 of the PPU 1300. The tasks are allocated to a particular DPC 1420 within a GPC 1350 and, if the task is associated with a shader program, the task may be allocated to an SM 1440. The scheduler unit 1510 receives the he CTAs that make up a task from the work distribution unit 1325 and manages instruction scheduling for one or more thread blocks assigned to the SM 1440. The scheduler unit 1510 schedules thread blocks for execution as warps of parallel threads, where each thread block consists of at least one warp. In an embodiment, each warp comprises 32 threads. The scheduler unit 1510 may manage a plurality of different thread blocks, allocating the different thread blocks to different warps and then dispatching instructions from the plurality of different cooperative groups to the various functional units (e.g., cores 1550, SFUs 1552, and LSUs 1554) during each clock cycle.

Cooperative Group Arrays (CGAs) provide a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Group Arrays enable programmers to define groups of threads explicitly at sub-block (e.g., as small as a single thread) and multi-block granularities, and to perform collective operations on the threads such as synchronization in a cooperative group. The programming model supports clean composition across software boundaries, so that libraries and utility functions can synchronize safely within their local context without having to make assumptions about convergence. Cooperative Group Array primitives enable new patterns of cooperative parallelism, including producer-consumer parallelism, opportunistic parallelism, and global synchronization across an entire grid of thread blocks. Hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety.

A dispatch unit 1515 is configured to transmit instructions to one or more of the functional units. In the embodiment, the scheduler unit 1510 includes two dispatch units 1515 that enable two different instructions from the same warp to be dispatched during each clock cycle. In alternative embodiments, each scheduler unit 1510 may include a single dispatch unit 1515 or additional dispatch units 1515.

Each SM 1440 includes a register file 1520 that provides a set of registers for the functional units of the SM 1440. In an embodiment, the register file 1520 is divided between each of the functional units such that each functional unit is allocated a dedicated portion of the register file 1520. In another embodiment, the register file 1520 is divided between the different warps being executed by the SM 1440. The register file 1520 provides temporary storage for operands connected to the data paths of the functional units.

Each SM 1440 comprises multiple processing cores 1550. In an embodiment, the SM 1440 includes a large number (e.g., 128, etc.) of distinct processing cores 1550. Each core 1550 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic.

Tensor cores are configured to perform matrix operations, and, in an embodiment, one or more tensor cores are included in the cores 1550. In particular, the tensor cores are configured to perform deep learning matrix arithmetic, such as convolution operations for neural network training and inferencing.

In some embodiments, transposition hardware is included in the processing cores 1550 or another functional unit (e.g., SFUs 1552 or LSUs 1554) and is configured to generate matrix data stored by diagonals and/or generate the original matrix and/or transposed matrix from the matrix data stored by diagonals. The transposition hardware may be provided inside of the SMEM 1570 to register file 1520 load path of the SM 1440.

Each SM 1440 also comprises multiple SFUs 1552 that perform special functions (e.g., attribute evaluation, reciprocal square root, and the like). In an embodiment, the SFUs 1552 may include a tree traversal unit (e.g., TTU 1443) configured to traverse a hierarchical tree data structure. In an embodiment, the SFUs 1552 may include texture unit (e.g., Texture Unit 1442) configured to perform texture map filtering operations. In an embodiment, the texture units are configured to load texture maps (e.g., a 2D array of texels) from the memory 1504 and sample the texture maps to produce sampled texture values for use in shader programs executed by the SM 1440. In an embodiment, the texture maps are stored in the SMEM/L1 cache 1470. The texture units implement texture operations such as filtering operations using mip-maps (e.g., texture maps of varying levels of detail). In an embodiment, each SM 1440 includes two texture units.

Each SM 1440 also comprises multiple LSUs 1554 that implement load and store operations between the SMEM/L1 cache 1570 and the register file 1520. Each SM 1440 includes an interconnect network 1580 that connects each of the functional units to the register file 1520 and the LSU 1554 to the register file 1520, SMEM/L1 cache 1570. In an embodiment, the interconnect network 1580 is a crossbar that can be configured to connect any of the functional units to any of the registers in the register file 1520 and connect the LSUs 1554 to the register file 1520 and memory locations in SMEM/L1 cache 1570.

The SMEM/L1 cache 1570 is an array of on-chip memory that allows for data storage and communication between the SM 1440 and the primitive engine 1435 and between threads in the SM 1440. In an embodiment, the SMEM/L1 cache 1570 comprises 128 KB of storage capacity and is in the path from the SM 1440 to the partition unit 1580. The SMEM/L1 cache 1570 can be used to cache reads and writes. One or more of the SMEM/L1 cache 1570, L2 cache 1460, and memory 1504 are backing stores.

Combining data cache and SMEM functionality into a single memory block provides the best overall performance for both types of memory accesses. The capacity is usable as a cache by programs that do not use SMEM. For example, if SMEM is configured to use half of the capacity, texture and load/store operations can use the remaining capacity. Integration within the SMEM/L1 cache 1570 enables the SMEM/L1 cache 1570 to function as a high-throughput conduit for streaming data while simultaneously providing high-bandwidth and low-latency access to frequently reused data.

In the context of this disclosure, an SM or “streaming multiprocessor” means a processor architected as described in U.S. Pat. No. 7,447,873 including improvements thereto and advancements thereof, and as implemented for example in many generations of NVIDIA GPUs. For example, an SM may comprise a plurality of processing engines or cores configured to concurrently execute a plurality of threads arranged in a plurality of single-instruction, multiple-data (SIMD) groups (e.g., warps), wherein each of the threads in a same one of the SIMD groups executes a same data processing program comprising a sequence of instructions on a different input object, and different threads in the same one of the SIMD group are executed using different ones of the processing engines or cores. An SM may typically also provide (a) a local register file having plural lanes, wherein each processing engine or core is configured to access a different subset of the lanes; and instruction issue logic configured to select one of the SIMD groups and to issue one of the instructions of the same data processing program to each of the plurality of processing engines in parallel, wherein each processing engine executes the same instruction in parallel with each other processing engine using the subset of the local register file lanes accessible thereto. An SM typically further includes core interface logic configured to initiate execution of one or more SIMD groups. As shown in the figures, such SMs have been constructed to provide fast local SMEM enabling data sharing/reuse and synchronization between all threads of a CTA executing on the SM.

When configured for general purpose parallel computation, a simpler configuration can be used compared with graphics processing. Specifically, the fixed function graphics processing units shown in FIG. 14A, are bypassed, creating a much simpler programming model. In the general purpose parallel computation configuration, the work distribution unit 1525 assigns and distributes blocks of threads directly to the DPCs 1420. The threads in a block execute the same program, using a unique thread ID in the calculation to ensure each thread generates unique results, using the SM 1440 to execute the program and perform calculations, SMEM/L1 cache 1570 to communicate between threads, and the LSU 1554 to read and write global memory through the SMEM/L1 cache 1570 and the memory partition unit 1580. When configured for general purpose parallel computation, the SM 1440 can also write commands that the scheduler unit 1520 can use to launch new work on the DPCs 1420.

The PPU 1300, or a multi-dielet GPU comprising multiple PPU as described in this disclosure, may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 1300 is embodied on a single semiconductor substrate. In another embodiment, the PPU 1300 is included in a system-on-a-chip (SoC) along with one or more other devices such as additional PPUs 1300, the memory 1504, a reduced instruction set computer (RISC) CPU, a memory management unit (MMU), a digital-to-analog converter (DAC), and the like.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 16A is a conceptual diagram of a processing system 1600 implemented using multi-dielet GPUs 1500 that include two or more of the PPU 1300 of FIG. 13, in accordance with an embodiment. The exemplary system 1600 may be configured to implement the methods disclosed in this application. The processing system 1600 includes a CPU 1630, switch 1655, and multiple multi-dielet GPUs each and respective memories 1504. The NVLink 1510 provides high-speed communication links between each of the multi-dielet GPUs. Although a particular number of NVLink 1510 and interconnect 1502 connections are illustrated in FIG. 16A, the number of connections to each multi-dielet GPU and the CPU 1630 may vary. The switch 1655 interfaces between the interconnect 1502 and the CPU 1630. The multi-dielet GPUs, memories 1504, and NVLinks 1510 may be situated on a single semiconductor platform to form a parallel processing module 1625. In an embodiment, the switch 1655 supports two or more protocols to interface between various different connections and/or links.

In another embodiment (not shown), the NVLink 1510 provides one or more high-speed communication links between each of the multi-dielet GPUs and the CPU 1630 and the switch 1655 interfaces between the interconnect 1502 and each of multi-dielet GPUs. The multi-dielet GPUs, memories 1504, and interconnect 1502 may be situated on a single semiconductor platform to form a parallel processing module 1625. In yet another embodiment (not shown), the interconnect 1502 provides one or more communication links between each of the multi-dielet GPUs and the CPU 1630 and the switch 1655 interfaces between each of the multi-dielet GPUs using the NVLink 1510 to provide one or more high-speed communication links between the multi-dielet GPUs. In another embodiment (not shown), the NVLink 1510 provides one or more high-speed communication links between the multi-dielet GPUs and the CPU 1630 through the switch 1655. In yet another embodiment (not shown), the interconnect 1502 provides one or more communication links between each of the multi-dielet GPUs directly. One or more of the NVLink 1510 high-speed communication links may be implemented as a physical NVLink interconnect or either an on-chip or on-die interconnect using the same protocol as the NVLink 1510.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1625 may be implemented as a circuit board substrate and each of the multi-dielet GPUs 1500 and/or memories 1504 may be packaged devices. In an embodiment, the CPU 1630, switch 1655, and the parallel processing module 1625 are situated on a single semiconductor platform.

In an embodiment, the NVLink 1510 allows direct load/store/atomic access from the CPU 1630 to each multi-dielet GPU's 1500 memory 1504. In an embodiment, the NVLink 1510 supports coherency operations, allowing data read from the memories 1504 to be stored in the cache hierarchy of the CPU 1630, reducing cache access latency for the CPU 1630. In an embodiment, the NVLink 1510 includes support for Address Translation Services (ATS), allowing the multi-dielet GPU 1500 to directly access page tables within the CPU 1630. One or more of the NVLinks 1510 may also be configured to operate in a low-power mode.

FIG. 16B illustrates an exemplary system 1665 in which the various architectures and/or functionalities of the various previous embodiments may be implemented. The exemplary system 1665 may be configured to implement the methods disclosed in this application.

As shown, a system 1665 is provided including at least one central processing unit 1630 that is connected to a communication bus 1675. The communication bus 1675 may be implemented using any suitable protocol, such as PCI (Peripheral Component Interconnect), PCI-Express, AGP (Accelerated Graphics Port), HyperTransport, or any other bus or point-to-point communication protocol(s). The system 1665 also includes a main memory 1640. Control logic (software) and data are stored in the main memory 1640 which may take the form of random access memory (RAM).

The system 1665 also includes input devices 1660, the parallel processing system 1625, and display devices 1645, e.g. a conventional CRT (cathode ray tube), LCD (liquid crystal display), LED (light emitting diode), plasma display or the like. User input may be received from the input devices 1660, e.g., keyboard, mouse, touchpad, microphone, and the like. Each of the foregoing modules and/or devices may even be situated on a single semiconductor platform to form the system 1665. Alternately, the various modules may also be situated separately or in various combinations of semiconductor platforms per the desires of the user.

Further, the system 1665 may be coupled to a network (e.g., a telecommunications network, local area network (LAN), wireless network, wide area network (WAN) such as the Internet, peer-to-peer network, cable network, or the like) through a network interface 1635 for communication purposes.

The system 1665 may also include secondary storage (not shown). Secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory, or the like. The removable storage drive reads from and/or writes to a removable storage medium in a well-known manner.

Computer programs, or computer control logic algorithms, may be stored in the main memory 1640 and/or secondary storage. Such computer programs, when executed, enable the system 1665 to perform various functions. The memory 1640, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1665 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

An application program may be implemented via an application executed by a host processor, such as a CPU. In an embodiment, a device driver may implement an application programming interface (API) that defines various functions that can be utilized by the application program in order to generate graphical data for display. The device driver is a software program that includes a plurality of instructions that control the operation of the multi-dielet GPU 1500 comprising 2 or more PPU 1300. The API provides an abstraction for a programmer that lets a programmer utilize specialized graphics hardware, such as the PPU 1300, to generate the graphical data without requiring the programmer to utilize the specific instruction set for the PPU 1300. The application may include an API call that is routed to the device driver for the multi-dielet GPU. The device driver interprets the API call and performs various operations to respond to the API call. In some instances, the device driver may perform operations by executing instructions on the CPU. In other instances, the device driver may perform operations, at least in part, by launching operations on the multi-dielet GPU 1500 utilizing an input/output interface between the CPU and the multi-dielet GPU. In an embodiment, the device driver is configured to implement the graphics processing pipeline utilizing the hardware of the PPU 1300.

Various programs may be executed within the multi-dielet GPU 1500 comprising 2 or more PPU 1300 in order to implement the various stages of the processing for the application program. For example, the device driver may launch a kernel on the PPU 1300 to perform one stage of processing on one SM 1440 (or multiple SMs 1440). The device driver (or the initial kernel executed by PPU 1300) may also launch other kernels on the PPU 1300 to perform other stages of the processing. If the application program processing includes a graphics processing pipeline, then some of the stages of the graphics processing pipeline may be implemented on fixed unit hardware such as a rasterizer or a data assembler implemented within the PPU 1300. It will be appreciated that results from one kernel may be processed by one or more intervening fixed function hardware units before being processed by a subsequent kernel on an SM 1440.

The techniques disclosed herein may be incorporated in any processor that may be used for processing a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA Geforce Now (GFN), Google Stadia, and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

All publications including but not limited to patent publications cited herein are incorporated herein by reference as if expressly set forth.

While the preceding is directed to embodiments of the present disclosure, other and further embodiments of the disclosure may be devised without departing from the scope thereof, and the scope of protection is therefore determined by combinations of elements and/or features of the claims that follow.

1. In a system including a first processor locally connected to a first memory and a second processor locally connected to a second memory, a method comprising:
selecting one of the first processor or the second processor to execute one or more threads associated with one or more pixels, wherein the selecting is based on screen location coordinates of the one or more pixels and a mapping, the mapping being configured to map pixels in a first plurality of areas of a screen to the locally connected memory of the one of the first processor or the second processor and to map pixels in a second plurality of areas of the screen to the locally connected memory of the other of the first processor or the second processor; and
storing data of the one or more pixels in a first surface of a render target in the locally connected memory of the one of the first processor or the second processor.

2. The method according to claim 1, wherein each area of the first plurality of areas and the second plurality of areas is a rectangular tile.

3. The method according to claim 1, wherein the selecting one of the first processor or the second processor comprises determining the one of the first processor or the second processor using arithmetic operations on the screen location coordinates.

4. The method according to claim 3, wherein the arithmetic operations include selecting a bit in the screen coordinates in a first dimension in accordance with respective anti-aliasing levels of the pixels.

5. The method according to claim 1, wherein the storing data of the one or more pixels in a first surface of a render target in the locally connected memory of the one of the first processor or the second processor comprises:
determining, based on a first address of the one or more pixels, a virtual address;
determining a physical address corresponding to the virtual address; and
determining, using a subset of bits in the physical address, the one of the first processor or the second processor.

6. The method according to claim 5, wherein the determining the virtual address is further based on a bits per pixel metric of the first surface.

7. The method according to claim 5, wherein the determining the physical address and the determining, using a subset of bits in the physical address, the one of the first processor or the second processor are independent of a bits per pixel metric of the first surface.

8. The method according to claim 7, wherein the subset of bits is determined independently of a bits per pixel metric of the first surface.

9. The method according to claim 5, wherein the first address is a blocklinear address of the one or more pixels, wherein the storing data of the one or more pixels in a first surface of a render target in the locally connected memory of the one of the first processor or the second processor further comprises, before the determining, based on a first address of the one or more pixels, a virtual address:
based on a bits per pixel metric of the first surface, determining whether to rearrange a second subset of bits in the blocklinear address; and
if it is determined to rearrange the second subset of bits, rearranging the second subset of bits in the blocklinear address.

10. The method according to claim 9, wherein the determining whether to rearrange a second subset of bits in the blocklinear address comprises:
if the bits per pixel metric of the first surface is greater than a first level, determining to rearrange the second subset of bits.

11. The method according to claim 9, wherein the second subset of bits is determined based on the bits per pixel metric of the first surface.

12. The method according to claim 9, wherein a unified memory of the system is interleaved over the locally connected memory of the one of the first processor or the second processor and the locally connected memory of the other of the first processor or the second processor, and wherein the virtual address is in the unified memory.

13. The method according to claim 12, wherein the first surface of the render target comprises data corresponding to pixels located in a subset of rectangular tiles associated with the first processor according to the mapping, wherein each of the areas of the first plurality of areas or each of the areas of the second plurality of areas is a rectangular tile in the subset of rectangular tiles, and each rectangular tile of the plurality of processor tiles comprises an even number of rendering tiles in at least one dimension.

14. The method according to claim 13, wherein each processor tile comprises an even number of rectangular blocks in at least one dimension of data arranged in a blocklinear format.

15. The method according to claim 13, wherein the render target comprises the first surface and a second surface stored in the locally connected memory of the one of the first processor or the second processor, and wherein the first surface has a first bits per pixel metric and the second surface has a second bits per pixel metric different from the first bits per pixel metric.

16. The method according to claim 1, further comprises:
determining, based on the screen location of the one or more pixels, a cluster of processing units on the one of the first processor or the second processor, wherein the cluster of processing units is assigned a rendering tile to which the one or more pixels belongs.

17. The method according to claim 1, further comprises:
storing a second surface in the render target corresponding to the one or more pixels to the locally connected memory of the one of the first processor or the second processor, wherein a bits per pixel metric of the second surface is different from that of the first surface.

18. The method according to claim 1, wherein the render target in the locally connected memory of the one of the first processor or the second processor includes a plurality of surfaces with each surface storing a different bits per pixel metric, and wherein the method further comprises:
processing, by a plurality of threads executing on the one of the first processor or the second processor, a rectangular tile of pixels that includes the one or more pixels by accessing respective surfaces of two different bits per pixel metrics in the locally connected memory of the one of the first processor or the second processor.

19. The method according to claim 1, wherein the first surface includes an associated localization indicator, and wherein the method further comprises:
processing, by the one of the first processor or the second processor, a rectangular tile of pixels that includes the one or more pixels by checking a status of the localization indicator of the first surface before accessing render targets in the first surface.

20. The method according to claim 1, wherein virtual addresses of the first surface are in a blocklinear address format and virtual addresses of a second surface of the plurality of surfaces are in a bit-rearranged format of corresponding blocklinear addresses, and wherein the method further comprises:
processing, by the one of the first processor or the second processor, a rectangular tile of pixels that includes the one or more pixels by determining an address in a same manner to access the first surface and the second surface.

21. The method according to claim 20, further comprising determining, by the one of the first processor or the second processor, a physical address of the first surface and a physical address of the second surface based on same address bits in corresponding virtual address.

22. The method according to claim 1, wherein the first surface includes render targets for all pixels in a rectangular tile of pixels that includes the one or more pixels, and wherein the method further comprises:
processing, by the one of the first processor or the second processor, the first surface without performing read operations over an interface connecting the first processor and the second processor.

23. The method according to claim 22, wherein the system is configured to use a unified memory in which the first processor and the second processor can access the locally connected memory of the other over the interface.

24. The method according to claim 1, wherein the system is configured to use a unified memory in which the first processor and the second processor can each access the locally connected memory of the other.

25. The method according to claim 24, wherein the unified memory is interleaved.

26. The method according to claim 24, wherein the unified memory is fine-interleaved between the locally connected memory of the first processor and a locally connected memory of the second processor.

27. The method according to claim 1, wherein the data of the one or more pixels is generated in a graphics pipeline executing on the one of the first processor or the second processor.

28. The method according to claim 1, wherein the data of the one or more pixels is generated by a compute shader executing on the first processor or the second processor.

29. The method according to claim 1, wherein the system enables access by each of multiple processors of the system to each other's locally connected memory via an interface connecting the multiple processors.

30. The method according to claim 1, wherein the first processor is disposed on a first die and the second processor is disposed on a second die, and a chip-to-chip interface connects the first die and the second die, and wherein each of the first processor and the second processor can access the locally connected memory of the other over the chip-to-chip interface.

31. A system comprising:
a first processor;
a second processor;
a first locally connected memory connected to the first processor;
a second locally connected memory connected to the second processor; and
configured to perform operations comprising:
selecting one of the first processor or the second processor to execute one or more threads associated with one or more pixels, wherein the selecting is based on screen location coordinates of the one or more pixels and a mapping, the mapping being configured to map pixels in a first plurality of areas of a screen to the locally connected memory of the one of the first processor or the second processor and to map pixels in a second plurality of areas of the screen to the locally connected memory of the other of the first die or the second die; and
storing data of the one or more pixels in a first surface of a render target in the locally connected memory of the one of the first processor or the second processor.

32. The system according to claim 31, comprising hardware circuitry configured for:
determining, based on a first address of the one or more pixels, a virtual address;
determining a physical address corresponding to the virtual address; and
determining, using a subset of bits in the physical address, the one of the first processor or the second processor.

33. The system, according to claim 31, wherein the hardware circuitry is further configured to, before the determining, based on a first address of the one or more pixels, a virtual address:
based on a bits per pixel metric of a first surface of the render target, determining whether to rearrange a second subset of bits in the blocklinear address; and
if it is determined to rearrange the second subset of bits, rearranging the subset of bits in the blocklinear address.

34. The system according to claim 31, wherein a unified memory of the system is interleaved over the first locally connected memory and the second locally connected memory, and wherein the virtual address is in the unified memory.

35. The system according to claim 31, wherein the first processor is disposed on a first die, the second processor is disposed on a second die, and further comprising one or more third dies each comprising a respective processor and being connected to a respective third locally connected memory, and further configured to perform operations comprising:
selecting one of the first die, the second die or any of the third dies to execute the one or more threads, wherein the selecting is based on screen location coordinates of the one or more pixels and the mapping, wherein the mapping is configured to map pixels in the first plurality of areas of the screen to the locally connected memory of the first die, to map pixels in a second plurality of areas of the screen to the locally connected memory of the second die, and to map pixels in one or more third plurality of areas of the screen to the respective locally connected memory of the one or more third dies; and
storing data of the one or more pixels in a first surface of a render target in the locally connected memory of the one of the first die, the second die, or the one or more third dies.
